(19) United States
(12) Patent Application Publication
(10) Pub. No.: US 2010/0058074 A1
(43) Pub. Date: Mar. 4, 2010

(54) RIGHT INFORMATION ENCRYPTION MODULE, NONVOLATILE MEMORY DEVICE, RIGHT INFORMATION RECORDING SYSTEM, RIGHT INFORMATION DECRYPTION MODULE, RIGHT INFORMATION READING SYSTEM, AND RIGHT INFORMATION RECORDING/READING SYSTEM

(76) Inventors: Hiroshi Sakurai, Osaka (JP); Hirofumi Nakagaki, Osaka (JP); Hirokazu So, Osaka (JP); Masahiro Nakanishi, Kyoto (JP)

Correspondence Address: MARK D. SARALINO (PAN);RENNER, OTTO, BOISSELLE & SKLAR, LLP, 1621 EUCLID AVENUE, 19TH FLOOR, CLEVELAND, OH, 44115, US

(21) Appl. No.: 12/594,965

(22) PCT Filed: Mar. 10, 2008
(86) PCT No.: PCT/JP2008/000504

§ 371 Date: Oct. 7, 2009

(30) Foreign Application Priority Data
Apr. 26, 2007 (JP) 2007-116773

(51) Int. Cl. G06F 12/14; H04L 9/00

(52) U.S. Cl. 713/193; 380/44; 711/E12.001; 711/E12.092

(57) ABSTRACT

A right information encryption module 110a comprises a key generation part 111a, a right information encryption part 112a, and a key management information generation part 113a. Key information Km and key management information Mm corresponding to right information are generated and then recorded into a secret recording module 130a. In addition, the right information is encrypted, and then the encrypted right information Enc_a (ROm, Km) and the key management information Mm are recorded into a recording module 140a. This can eliminate the possibility of a capability shortage of a secret area caused by an increase in the data size of the right information including the key information and use restriction information for a content.

### TECHNICAL FIELD

The present invention relates to a right information encryption module, nonvolatile memory device, and right information recording system for safely recording: a use condition for encrypted contents; and right information including a key, and relates to a right information decryption module, nonvolatile memory device, right information reading system, and right information recording/reading system for reading the right information related to the encrypted contents for the purpose of decrypting and using the encrypted contents.

### BACKGROUND ART

A network contents distribution service is widely spread; a contents distribution company distributes to a user terminal a pay electronic content (hereinafter simply referred to as a content) such as a piece of music, a movie, and a book to which a use restriction is imposed by a content holder in the service distributes. Since being the electronic information, the content can be easily copied, and thus the copyright of the content may be infringed because of the illegal copy. Accordingly, in order to prevent the illegal copy of the content, the contents distribution company usually encrypts the content and distributes the encrypted content to the user terminal. Generally, the distributed content is firstly recorded in a recording medium and then is watched by a plurality of the user terminals.

The contents distribution company creates a key used for encrypting the content as a part of contents right information (hereinafter simply referred to as right information), and distributes the key to the user terminal in addition to the content. In these years, the contents distribution company adds the reproduction management number of times and the reproduction management term to the right information in order to provide a flexible service. Thus, a data amount of the right information tends to increase.

Regarding the right information, it needs to prevent an act disadvantageous for the content holder such as the purposely-falsifying of the reproduction management number of times and the reproduction management term information by an ordinary user. Accordingly, a conventional method employs a technique for preparing in a nonvolatile memory device a secret region where the ordinary user cannot directly read and write data separately from a user region where the ordinary user can directly read and write data and recording the right information in the secret region.

FIG. 1 is a schematic view of the conventional method for receiving an encrypted content Enc_b (COm, ROm) and the right information ROm distributed from a network contents distribution server 730 at a recording device 720 of a user terminal and recording the received content and information in a nonvolatile memory device 710.

In the network contents distribution server 730, a contents encryption part 731 encrypts a content COm by using a contents key included in the right information ROm and generates the encrypted content Enc_b (COm, ROm).

The recording device 720 is used as the user terminal, receives the right information ROm through a secure network 732, and receives the encrypted content Enc_b (COm, ROm). In the nonvolatile memory device 710, a mounted nonvolatile memory is divided into a secret region 711 and a user region 712.

The recording device 720 records the right information ROm in the secret region 711 of the nonvolatile memory device 710 through a secret communication means 722, and records the encrypted content Enc_b (COm, ROm) in the user region 712 by using a conventional writing means. Here, when a size of the secret region 711 is expanded, a size of the user region 712 that a user can freely use becomes small and thereby a user's convenience is impaired, and accordingly it is required to minimize the size of the secret region 711.

FIG. 2 is a schematic view of a conventional method for reproducing the encrypted content Enc_b (COm, ROm) recorded in the nonvolatile memory device 710.

A reproduction device 721 reads the encrypted content Enc_b (COm, ROm) recorded in the user region 712 of the nonvolatile memory device 710 by using a conventional reading part. In addition, the device reads the right information ROm recorded in the secret region 711 via the secret communication means 722. And, a contents decryption part 723 decrypts the encrypted content Enc_b (COm, ROm) by using the contents key included in the right information ROm, and the device reproduces the content Com.

However, since the size of the secret region has to be fixed and the data amount of the right information ROm tends to increase, the size of the secret region has to be preliminarily large. Accordingly, the conventional method has a problem of reducing a region that a user can use.

Patent document 1 discloses a method to improve the problem. FIG. 3 is a schematic view showing a right information recording system according to Patent document 1. As shown in this drawing, a recording device 750 receives static information IDu specific to a user from an IC card 740 and the like. An encryption part 751 encrypts the static information IDu of the IC card by using a specific ID existing in a system region 713 of the nonvolatile memory device 710, and records the encrypted result in the secret region 711 of the nonvolatile memory device 710. Then, the system reads the encrypted information and a decryption part 752 decrypts the information, and a right information encryption part 753 encrypts the right information ROm given from the contents distribution server by using the decrypted static information and records the encrypted right information in the user region 712. In addition, the recording device 750 records a content encrypted by the contents encryption part 731 in the user region 712 of the nonvolatile memory device 710. In this manner, the recording system encrypts the right information ROm by using the static information IDu, and then records the encrypted right information in the user region 712 and records only the encrypted static information in the secret region 711.

FIG. 4 is a view showing a right information reading system. A reproduction device 760 reads an ID specific to the card from a system region of the nonvolatile memory device 710, reads the encrypted static information retained in the secret region 711, and decrypts the static information at a decryption part 761. Then, the device decrypts the right information in the user region 712 at a decryption part 762 by using the decrypted static information IDu. Moreover, the device decrypts the encrypted content in the user region at a contents decryption part 763 by using the decrypted right information and reproduces the content.

Patent document 1: Japanese Unexamined Patent Publication No. 2004-194271

### DISCLOSURE OF THE INVENTION

### Problems To Be Solved By the Invention

However, since separately requiring the static information IDu, the method increases information to be managed by a user and increases a management burden of the user. Since all of the right information recorded in a user region of a recording medium are encrypted by using one piece of the static information IDu as a key, all of the right information are at risk of the illegal use if the static information IDu is leaked. In addition, since a new encryption part and decryption part are added to a conventional recording device and reproducing device, the recording device and reproducing device have to be newly designed.

The present invention intends to provide a right information encryption module, a nonvolatile memory device, a right information recording system, a right information decryption module, a right information reading system, and a right information recording/reading system that are able to eliminate a possibility of capacity shortage of the secret region, the capacity shortage being caused by increase of data of the right information, without causing the above-mentioned problems.

### Means To Solve the Problems

To solve the problem, a nonvolatile memory device of the present invention comprises: a right information encryption module for encrypting and recording right information; a right information decryption module for reading and decrypting the encrypted right information; a secret recording module for recording highly-secret information; and a recording module for recording arbitrary information, wherein said right information encryption module includes: a key generation part for generating key information used for encrypting the right information; a right information encryption part for generating encrypted right information by encrypting the right information of an encrypted content inputted from an external device by using the key information generated by said key generation part; a key information recording part for generating key management information that relates the key information generated by said key generation part to the encrypted right information and for relating said key information to said key management information and for recording said key information and key management information in said secret recording module; and a right information recording part for relating said key management information to said encrypted right information and for recording said key management information and said encrypted right information in said recording module, and wherein said right information decryption module includes: a right information reading part for reading the encrypted right information and the key management information that are connected each other and are recorded in said recording module; a key information reading part for reading the key information related to said key management information from said secret recording module; and a right information decryption part for decrypting the encrypted right information by using said key information.

To solve the problems, a nonvolatile memory device of the present invention comprises: a right information encryption module for encrypting and recording right information; a secret recording module for recording highly-secret information; and a recording module for recording arbitrary information, wherein said right information encryption module includes: a key generation part for generating key information used for encrypting the right information; a right information encryption part for generating encrypted right information by encrypting the right information of an encrypted content inputted from an external device by using the key information generated by said key generation part; a key information recording part for generating key management information that relates the key information generated by said key generation part to the encrypted right information and for relating said key information to said key management information and for recording said key information and key management information in said secret recording module; and a right information recording part for relating said key management information to said encrypted right information and for recording said key management information and said encrypted right information in said recording module.

Said right information recording part may relate said key management information to said encrypted right information and output said key management information and said encrypted right information to an external apparatus and said external apparatus may output said key management information and said encrypted right information to said recording module.

Said right information recording part may relate said key management information to said encrypted right information and output said key management information and said encrypted right information to an external apparatus and said external apparatus may output said key management information and said encrypted right information to said recording module.

To solve the problems, a nonvolatile memory device of the present invention comprises: a right information decryption module for reading and decrypting the encrypted right information; a secret recording module for recording highly-secret information; and a recording module for recording arbitrary information, wherein said right information decryption module includes: a right information reading part for reading key management information and encrypted right information obtained by encrypting right information of an encrypted content, the key management information and the encrypted right information being related each other and recorded in said recording module; a key information reading part for reading the key information related to said key management information from said secret recording module; and a right information decryption part for decrypting the encrypted right information by using said key information.

Said key management information and said encrypted right information that are connected each other may be once read from said recording module by an external apparatus and inputted to said right information reading part.

To solve the problems, a right information recording/reading system of the present invention comprises: a nonvolatile memory device; a right information outputting/reading device for writing and reading right information in and from said nonvolatile memory device; and a secret communication means for carrying out a secret communication between said nonvolatile memory device and said right information outputting/reading device, wherein said nonvolatile memory device comprises: a right information encryption module for encrypting and recording right information; a right information decryption module for reading and decrypting the encrypted right information; a secret recording module for recording highly-secret information; and a recording module for recording arbitrary information, said right information encryption module includes: a key generation part for generating key information used for encrypting the right information; a right information encryption part for generating encrypted right information by encrypting the right information of an encrypted content inputted from an external device by using the key information generated by said key generation part; a key information recording part for generating key management information that relates the key information generated by said key generation part to the encrypted right information and for relating said key information to said key management information and recording said key information and key management information in said secret recording module; and a right information recording part for relating said key management information to said encrypted right information and for recording said key management information and said encrypted right information in said recording module, said right information decryption module includes: a right information reading part for reading the encrypted right information and the key management information that are connected each other and are recorded in said recording module; a key information reading part for reading the key information related to said key management information from said secret recording module; and a right information decryption part for decrypting the encrypted right information by using said key information, said right information outputting/reading device inputs the right information of the encrypted content to said nonvolatile memory device by using said secret communication means, and said nonvolatile memory device outputs the right information of the encrypted content to said right information outputting/reading device by using said secret communication means.

To solve the problems, a right information recording/reading system of the present invention comprises: a nonvolatile memory device; a right information output device for writing right information in said nonvolatile memory device; and a secret communication means for carrying out a secret communication between said nonvolatile memory device and said right information output device, wherein said nonvolatile memory device comprises: a right information encryption module for encrypting and recording right information; a secret recording module for recording highly-secret information; and a recording module for recording arbitrary information, said right information encryption module includes: a key generation part for generating key information used for encrypting the right information; a right information encryption part for generating encrypted right information by encrypting the right information of an encrypted content inputted from an external device by using the key information generated by said key generation part; a key information recording part for generating key management information that relates the key information generated by said key generation part to the encrypted right information and for relating said key information to said key management information and recording said key information and key management information in said secret recording module; and a right information recording part for relating said key management information to said encrypted right information and for recording said key management information and said encrypted right information in said recording module, and said right information output device outputs the right information of the encrypted content to said nonvolatile memory device by using said secret communication means.

To solve the problems, a right information recording/reading system of the present invention comprises: a nonvolatile memory device; a right information output device for writing right information in said nonvolatile memory device; and a secret communication means for carrying out a secret communication between said nonvolatile memory device and said right information output device, wherein said nonvolatile memory device comprises: a right information decryption module for reading and decrypting the encrypted right information; a secret recording module for recording highly-secret information; and a recording module for recording arbitrary information, said right information decryption module includes: a right information reading part for reading key management information and encrypted right information obtained by encrypting right information of an encrypted content, the key management information and the encrypted right information being related each other and recorded in said recording module; a key information reading part for reading the key information related to said key management information from said secret recording module; and a right information decryption part for decrypting the encrypted right information by using said key information, and said nonvolatile memory device outputs the decrypted right information of the encrypted content to said right information reading device by using said secret communication means.

To solve the problems, a right information encryption module of the present invention comprises: a key generation part for generating key information used for encrypting right information; a right information encryption part for generating encrypted right information by encrypting the right information of an encrypted content inputted from an external device by using the key information generated by said key generation part; a key information recording part for generating key management information that relates the key information generated by said key generation part to the encrypted right information generated by said right information encryption part and for relating said key information to said key management information and outputting said key information and key management information to an external device; and a right information recording part for relating said key management information to said encrypted right information and for recording said key management information and said encrypted right information in said recording module.

Said right information recording part may relate said key management information to said encrypted right information and output said key management information and said encrypted right information to the external device.

To solve the problems, a right information decryption module of the present invention comprises: a right information reading part for inputting encrypted right information and key management information that are related each other from an external device; a key information reading part for inputting key information related to said key management information from the external device; and a right information decryption part for decrypting the encrypted right information by using said key information and for outputting the decrypted information to the external device.

Said right information reading part may input said key management information and said encrypted right information that are related each other from the external device.

### Effectiveness of the Invention

A right information encryption module, a nonvolatile memory device, a right information recording system, a right information decryption module, a right information reading system, and a right information recording/reading system of the present invention reduce a size of data to be recorded in a secret region and does not newly require static information IDu to reduce information to be managed by a user, resulting in reduction of a management burden of the user. In addition, all pieces of right information to be recorded in a user region of the nonvolatile memory device are encrypted by individual keys generated in a recording medium, and if the key information is leaked, other pieces of the right information are not at risk of the illegal use. Since the key information used for encrypting the right information is not outputted to an outside of the nonvolatile memory device, the risk of leaking the information key is low.

In addition, a new encryption part and decryption part do not have to be added to a conventional recording device and reproducing device.

### BRIEF DESCRIPTION OF DRAWINGS

FIG. 1 is a schematic view showing a configuration of a conventional right information recording system.

FIG. 2 is a schematic view showing a configuration of a conventional right information recording system.

FIG. 3 is a schematic view showing a configuration of a conventional right information recording system.

FIG. 4 is a schematic view showing a configuration of a conventional right information recording system.

FIG. 5 is a schematic view showing a right information encryption module according to a first embodiment of the present invention.

FIG. 6A is a schematic view showing a first modification example of the right information encryption module according to the first embodiment of the present invention.

FIG. 6B is a view showing one example of a key management table of the modification example.

FIG. 7A is a schematic view showing a second modification example of the right information encryption module according to the first embodiment of the present invention.

FIG. 7B is a view showing one example of a secret recording module of the modification example.

FIG. 8 is a schematic view showing a third modification example of the right information encryption module according to the first embodiment of the present invention.

FIG. 9 is a schematic view showing a right information encryption module according to a second embodiment of the present invention.

FIG. 10A is a schematic view showing a first modification example of the right information encryption module according to the second embodiment of the present invention.

FIG. 10B is a view showing one example of a key management table of the modification example.

FIG. 11A is a schematic view showing a second modification example of the right information encryption module according to the second embodiment of the present invention.

FIG. 11B is a view showing one example of a secret recording module of the modification example.

FIG. 12 is a schematic view showing a third modification example of the right information encryption module according to the second embodiment of the present invention.

FIG. 13 is a schematic view showing a right information encryption module according to a third embodiment of the present invention.

FIG. 14 is a schematic view showing a first modification example of the right information encryption module according to the third embodiment of the present invention.

FIG. 15 is a schematic view showing a second modification example of the right information encryption module according to the third embodiment of the present invention.

FIG. 16 is a schematic view showing a third modification example of the right information encryption module according to the third embodiment of the present invention.

FIG. 17 is a schematic view showing a right information encryption module according to a fourth embodiment of the present invention.

FIG. 18 is a schematic view showing a first modification example of the right information encryption module according to the fourth embodiment of the present invention.

FIG. 19 is a schematic view showing a second modification example of the right information encryption module according to the fourth embodiment of the present invention.

FIG. 20 is a schematic view showing a third modification example of the right information encryption module according to the fourth embodiment of the present invention.

FIG. 21 is a schematic view showing one configuration example of a nonvolatile memory device according to a fifth embodiment of the present invention.

FIG. 22 is a schematic view showing one configuration example of a nonvolatile memory device according to a sixth embodiment of the present invention.

FIG. 23 is a schematic view showing one configuration example of a nonvolatile memory device according to a seventh embodiment of the present invention.

FIG. 24 is a schematic view showing one configuration example of a nonvolatile memory device according to an eighth embodiment of the present invention.

FIG. 25 is a schematic view showing one configuration example of a nonvolatile memory device according to a ninth embodiment of the present invention.

FIG. 26 is a schematic view showing one configuration example of a right information recording system according to a tenth embodiment of the present invention.

FIG. 27 is a schematic view showing a modification example of the right information recording system according to the tenth embodiment of the present invention.

FIG. 28 is a schematic view showing a modification example of a right information reading system according to an eleventh embodiment of the present invention.

FIG. 29 is a schematic view showing one configuration example of the right information reading system according to the eleventh embodiment of the present invention.

FIG. 30 is a schematic view showing a modification example of a right information recording/reading system according to a twelfth embodiment of the present invention.

### EXPLANATION FOR REFERENCE NUMERALS

110a, 110b, 110c, 110d, 110e, 110f, 110g, and 110h Right information encryption module

111a Key generation part

112a Right information encryption part

114a, 114b, 114c, 114d, 114e, 114f, and 114g Key information recording part

115a, 115c, and 115d Right information recording part

116b and 116f Key management table

117e and 117f Falsification detection data generation part

120a, 120d, and 220d External apparatus

130a Secret recording module

140a Recording module

210a, 210b, 210c, 210d, 210e, 210f, 210g, and 210h Right information decryption module

212a Right information decryption part

214a, 214b, 214c, 214e, 214f, and 214g Key information reading part

215a, 215c, 215d, 215g, and 215h Right information reading part

218e Right information falsification detection part

310a, 310e, and 310h Nonvolatile memory device

320d External apparatus

330a Secret recording module

340a Recording module

410a, 410e, 410h, and 410 Nonvolatile memory device

520a and 520b Right information output device

550a Secret communication means

560a Contents distribution server

561a Secure network

562a Non-secure network

563a Contents encryption part

620a and 620b Right information reading device

650a Secret communication means

661a Contents encryption part

### BEST MODE FOR CARRYING OUT THE INVENTION

Referring to drawings, embodiments of the present invention will be explained below. Notation of abbreviations in the present specification will be explained.

ROm: Right information of an encrypted content, including contents key information and contents view limitation information used for decrypting a content.

Km: Key information for encrypting and decrypting the right information, used when encrypting and decrypting one or more pieces of the right information.

Mm: Key management information relating the key information to the encrypted right information.

Am: Internal storage address of a secret recording module.

Hm: Falsification detection data used for a falsification detection of the right information.

Enc_x (A, B): Information obtained by encrypting A with a key of B in an encryption method X.

Enc_x and Dec_x: An encryption method and a decryption method in the x method, respectively.

The same numerals are added to the same components in the following respective embodiments and their modification examples, and detailed explanations of the same components will be omitted after their second appearance and different components will be mainly described.

### First Embodiment

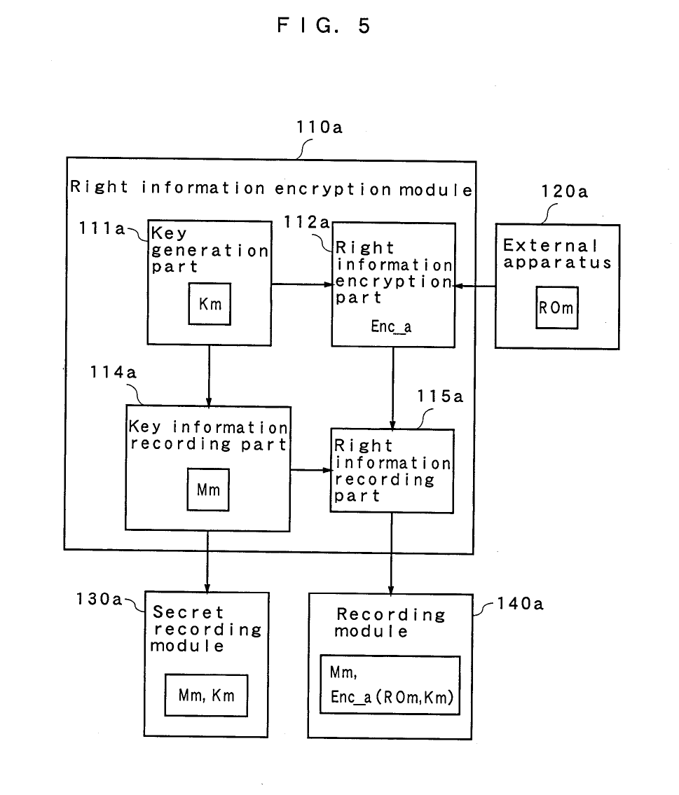

FIG. 5 shows a configuration of a right information encryption module according to a first embodiment of the present invention. In FIG. 5, an external apparatus 120a is, for example, a personal computer or a digital camera, which can load a nonvolatile memory device. A right information encryption module 110a, a secret recording module 130a, and a recording module 140a are equivalent to a nonvolatile memory device, for example, an SD memory card (Registered trademark), and the secret recording module 130a and the recording module 140a can be realized as the internal nonvolatile memory. The right information encryption module 110a encrypts right information ROm retained by the external apparatus 120a and records the information.

The right information encryption module 110a internally has a key generation part 111a for generating a piece of key information Km based on the right information ROm given from the external apparatus 120a. The key information Km generated by the key generation part 111a is a string of random numbers serving as a unique value in each of the right information or in units of a plural pieces of the right information, or is a value equivalent to the string of random numbers. In addition, m is the natural number used for specifying each of the key information.

A right information encryption part 112a encrypts the right information ROm on the basis of the key information Km generated by the key generation part 111a. As an encryption method used by the right information encryption part 112a, the DES, the triple DES, the AES code, and the like are generally employed, but the encryption method is not limited to them and an arbitrary encryption method may be employed.

The key information recording part 114a generates a piece of key management information Mm in each of the key information Km, and connects the key management information Mm to the key information Km and records them in the secret recording module 130a. The key management information Mm is used for relating the key information Km to a piece of encrypted right information Enc_a (ROm, Km), and arbitrary information can be determined as the management information if being able to be distinguished from other key information. When the key management information Mm is used, the key information Km can be specified in decrypting the encrypted right information Enc_a (ROm, Km).

The right information recording part 115a records the encrypted right information Enc_a (ROm, Km) and the key management information Mm in the recording module 140a.

The secret recording module 130a is a recording module that cannot be accessed from other than the key information recording part 114a. The recording module 140a can be accessed also from other than the right information recording part 115a, and records data other than the encrypted right information.

Next, an operation of the present embodiment will be explained. The external apparatus 120a inputs the right information ROm to the right information encryption part 112a, and the key generation part 111a inputs the generated key information Km to the right information encryption part 112a. The right information encryption part 112a encrypts the right information ROm in an encryption method a, and outputs the encrypted right information Enc_a (ROm, Km) to the right information recording part 115a. The right information recording part 115a connects the key management information Mm to the encrypted right information Enc_a (ROm, Km), and records them in the recording module 140a. Meanwhile, the key information recording part 114a connects the key management information Mm to the key information Km, and records them in the secret recording module 130a. In this manner, since the sizes of the key management information Mm and the key information Km are small, the size of information to be recorded in the secret recording module 130a also can be small.

The secret recording module 130a and the recording module 140a may be configured by dividing a region of an identical nonvolatile memory. In this case, the division of the region has to be clearly separated. In the case where the secret recording module 130a and the recording module 140a are configured in an identical nonvolatile memory, a memory size of the nonvolatile memory is limited, and accordingly a memory size of the recording module 140a that a user can freely use is reduced when a memory size of the secret recording module 130a is large. However, since an amount of data to be recorded in the secret recording module 130a is small in the present embodiment, larger memory size can be allocated to the recording module 140a and thus a user's convenience is improved.

The secret module 130a and the recording module 140a may be configured in separate nonvolatile memories. In this case, it is preferable to employ an EEPROM suitable for access in small units of data as the secret module 130a and employ an NAND type flash memory suitable for a large memory capacity as the recording module 140a. The EEPROM is expensive compared to the NAND type flash memory, but since the amount of data to be recorded in the secret recording module 130a is small in the present embodiment, a memory size required for the EEPROM can be reduced and thereby the cost can be reduced.

The present embodiment does not require the static information IDu specific to a user according to Patent document 1. The right information ROm recorded in the recoding module 140a is encrypted originally on the basis of the individual key information Km generated by the key generation part 111a, and even if one piece of the key information is leaked, other pieces of the right information accordingly are not at risk of the illegal use. In addition, since the key information Km used for encrypting the right information ROm is not outputted to outsides of the right information encryption module 110a and the secret recording module 130a, the key information Km is not at risk of the leaking to the outside.

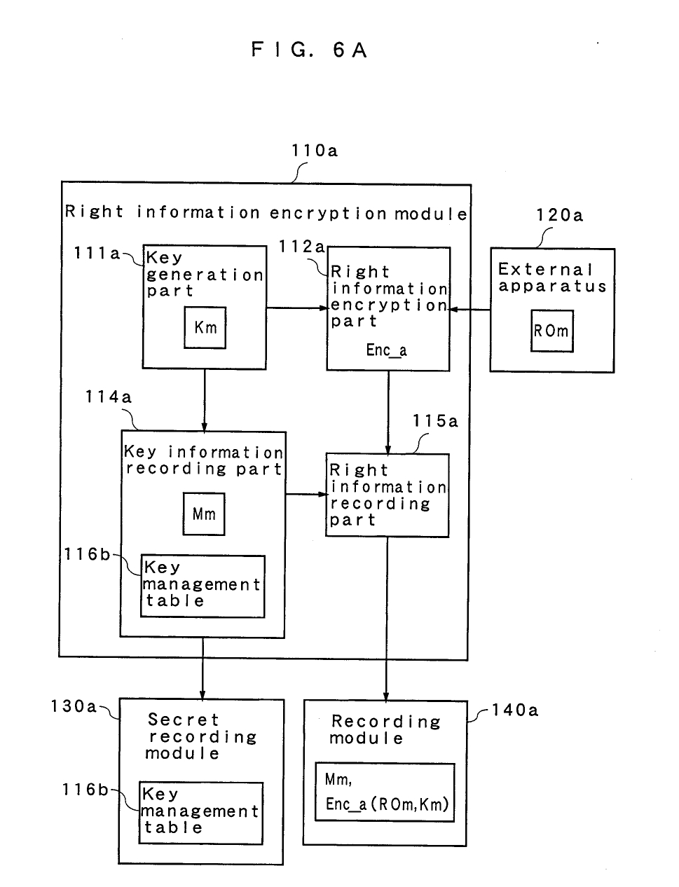

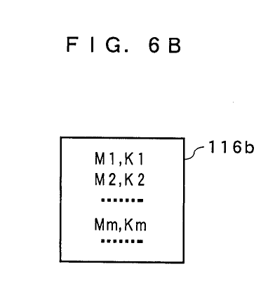

FIG. 6A shows a first modification example of the first embodiment. In this modification example, a key information recording part 114b generates a key management table 116b for relating the key management information Mm to the key information Km, and outputs the key management table 116b to the secret module 130a. FIG. 6B shows an example of the key management table 116b, and records a pair of the key management information M1 and the key information K1, a pair of the key management information M2 and the key information K2, in the table. The secret recording module 130a safely records the key management table 116b as one file. In this manner, necessary data can be easily read from the key management table 116b.

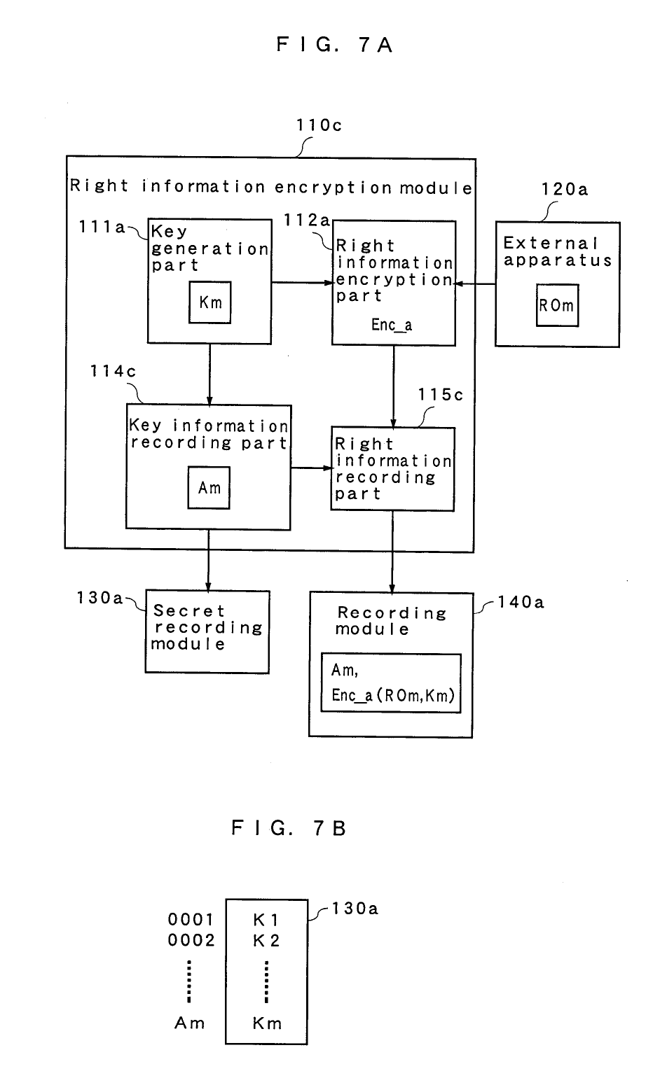

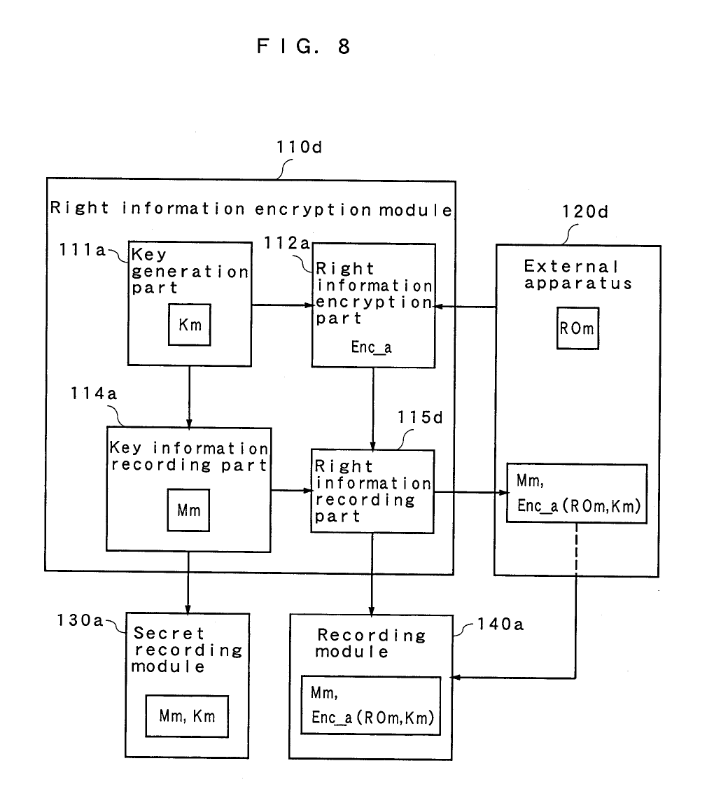

FIG. 7A shows a second modification example of the first embodiment. In this modification example, a key information recording part 114c stores the right information Km in an address Am of the secret recording module 130a. FIG. 7B shows recoding contents of the secret recording module 130a, and shows that the key information K1 is recorded at address 0001, the key information K2 is recorded at address 0002, . . . , and the key information Km is recorded at address Am. Moreover, the key information recording part 114c determines a storage address of the secret recoding module 130a as the key management information Am, and outputs the information to the right information recording part 115c. The right information recording part 115c connects the key management information Am to the encrypted right information Enc_a (ROm, Km), and outputs them to the recording module 140a and records them in the module.

In addition, the key information K1 to Km are subsequently recorded at continuous addresses from 0001 in FIG. 7B, but the information may be recorded at an arbitrary address and the addresses may be outputted to the right information recording part 115c.

FIG. 8 shows a third modification example of the first embodiment. In this modification example, a right information recording part 115d connects the key management information Mm to the encrypted right information Enc_a (ROm, Km), and once outputs them to an external apparatus. Then, the external apparatus 120d outputs the information to the recording module 140a, and records them in the recording module 140a. In this manner, the external apparatus 120d can write the information to the recording module 140a in the same manner as that to other data on the basis of a file system, and the external apparatus 120d can recognize which region the data has been written to.

### Second Embodiment

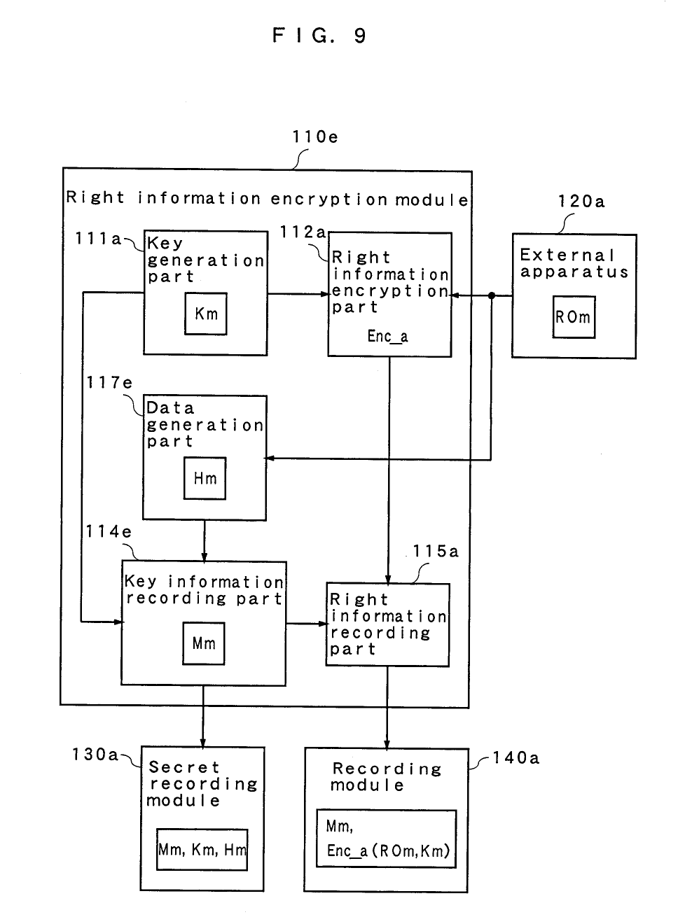

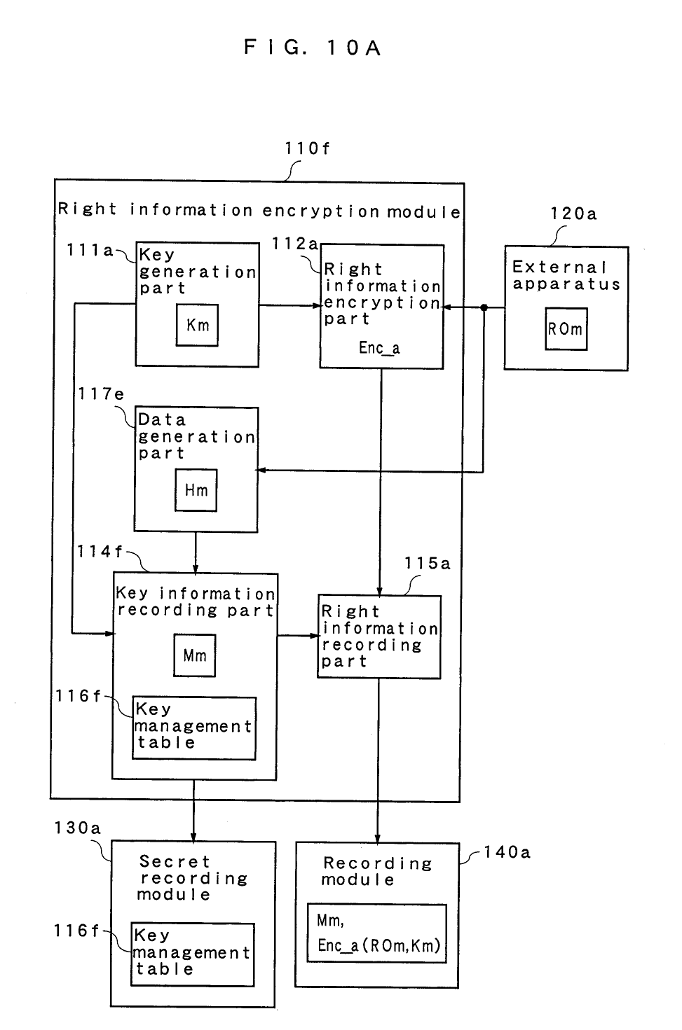

Next, referring to FIG. 9, a second embodiment of the present invention will be explained. In this embodiment, a falsification detection data generation part (hereinafter simply referred to as a data generation part) 117e is added to a right information encryption module 110e. The data generation part 117e generates right information falsification detection data (hereinafter simply referred to as falsification detection data) Hm from the right information ROm in order to judge in decrypting the encrypted right information whether or not the right information ROm is falsified. The falsification detection data Hm is generated generally by using: a hush function such as the SHA1 or the SHA256; and an authentication function such as the CBC-MAC or the CMAC. The falsification detection data Hm is used as comparison data of a case of carrying out the falsification verification as to whether the right information ROm obtained by decrypting the encrypted right information Enc_a (ROm, Km) is a right value or not. The data generation part 117e outputs the falsification detection data Hm to the key information recording part 114e, and the key information recording part 114e connects the key management information Mm, the key information Km, and the falsification detection data Hm to each other, and outputs them to the secret recording module 130a. The secret recording module 130a safely records them.

In this manner, in a case where a malicious user illegally falsified the encrypted right information Enc_a (ROm, Km) recorded in the recoding module 140a, the embodiment can detect in the reading whether or not the falsification has been made.

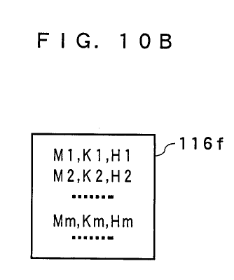

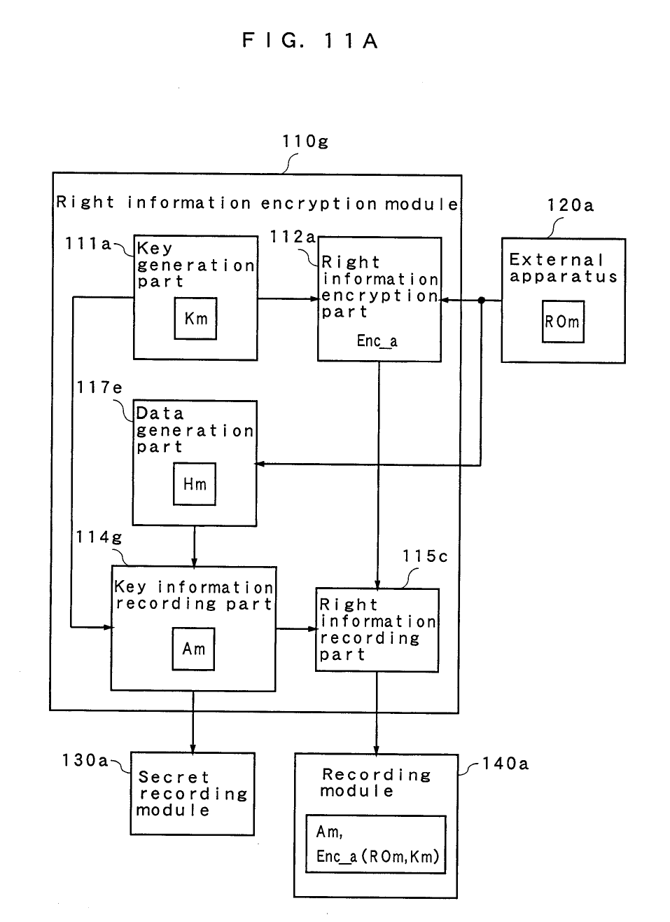

FIG. 10A is a first modification example of the second embodiment, and adds a data generation part 117e to the first modification example of the first embodiment. The data generation part 117e outputs the falsification detection data Hm to a key information recording part 114f. The key information recording part 114f generates the key management table 116f for relating the key management information Mm, the key information Km, and the falsification detection data Hm to each other. FIG. 10B shows one example of this table 116f. The key information recording part 114f safely records the key management table 116f in the secret module 130a.

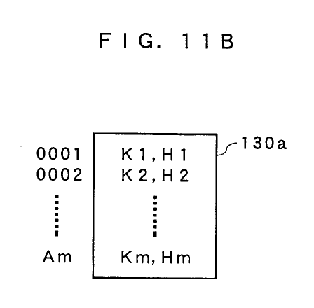

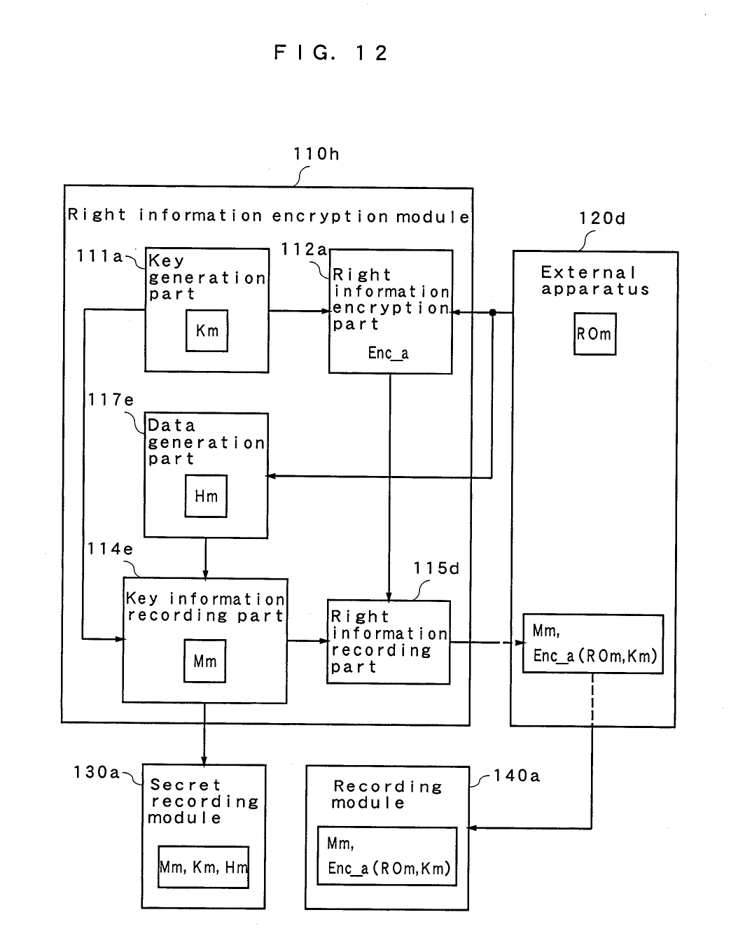

FIG. 11A shows a second modification example of the second embodiment, and the modification example is configured by adding a data generation part 117e to the second modification example of the first embodiment. The data generation part 117e inputs the falsification detection data Hm to the key information recording part 114g. The key information recording part 114g records the key management information at the address Am of the secret recording module 130a, and connects the key information Km to the right information falsification detection data Hm and records them to the secret recording module 130a. As shown in FIG. 11B, the secret recording module 130a safely records them.

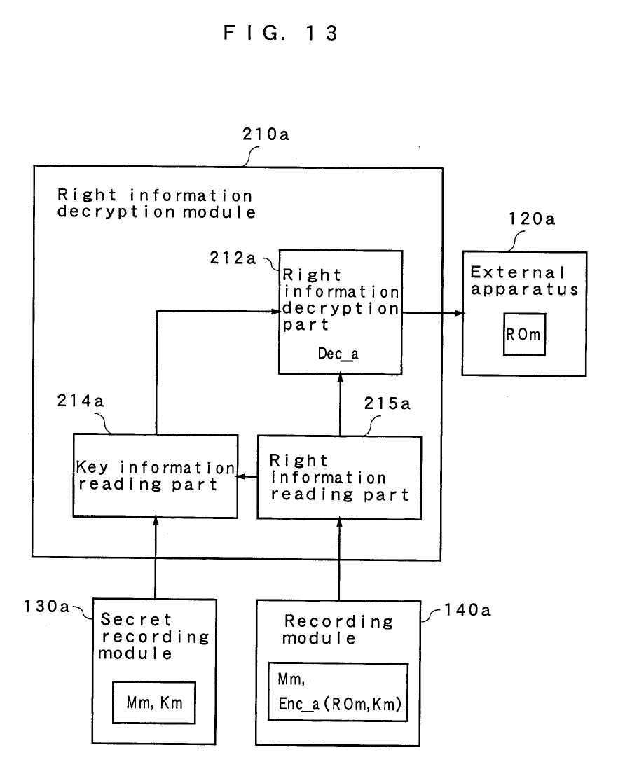

FIG. 12 is a third modification example of the second embodiment, and the modification example is configured by adding the data generation part 117e to the third modification example of the first embodiment. In the present modification example, the right information recording part 115d connects the key management information Mm to the encrypted right information Enc_a (ROm, Km), and once outputs them to the external apparatus 120d. Then, the external apparatus 120d outputs the information to the recording module 140a, and the recording module 140a records the information. In this manner, the external apparatus 120d can write the information to the recording module in the same manner as that to other data on the basis of a file system, and the external apparatus 120d can recognize which region the data has been written to.

### Third Embodiment

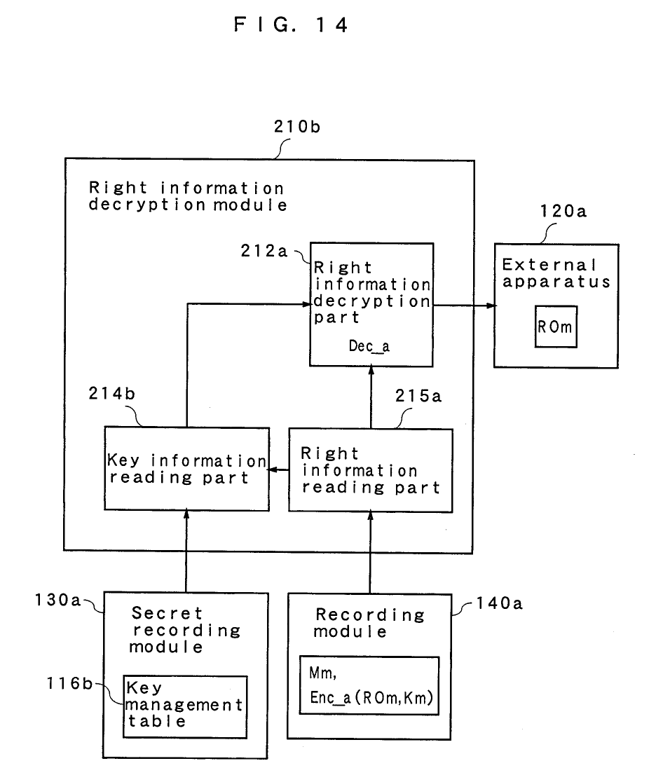

FIG. 13 shows a configuration of a right information decryption module according to a third embodiment of the present invention. The present embodiment reads the right information stored in the right information encryption module of the first embodiment and decrypts the right information. The right information decryption module 210a includes a right information decryption part 212a for decrypting the right information, a key information reading part 214a, and a right information reading part 215a. As a decryption method used in the right information decryption part 212a, the same method as the encryption method used in the right information encryption part 112a of the first embodiment is employed.

Next, an operation of the present embodiment will be explained. The right information reading part 215a reads the connected encrypted right information Enc_a (ROm, Km) recorded in the recording module 140a and outputs the information to the right information decryption part 212a, and reads the key management information Mm and outputs the information to the key information reading part 214a. The key information reading part 214a reads the key information Km connected to the key management information Mm from the secret recording module 130a, and outputs the information to the right information decryption part 212a. The decryption part 212a decrypts the encrypted right information Enc_a (ROm, Km) by using the key information Km, and outputs the right information ROm to the external apparatus 120a.

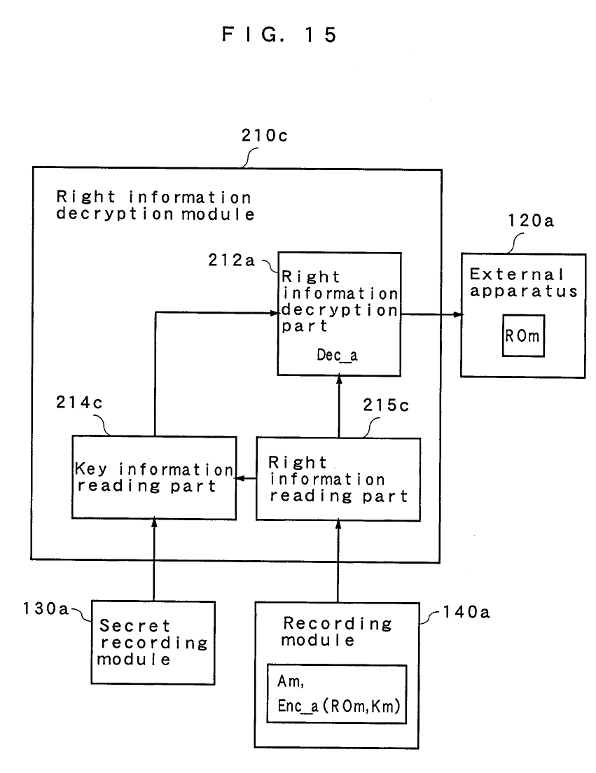

FIG. 14 shows a right information decryption module 210b according to a first modification example of the third embodiment of the present invention. This modification example reads the right information stored in the right information encoding module in the first modification example of the first embodiment and decrypts the information. Here, the right information reading part 215a outputs the key management information Mm read together with the encrypted right information in the recording module 140a to a key information reading part 214b. The key information reading part 214b reads the key management table 116b from the secret module 130a, and outputs the key information Km related to the key information Mm to the decryption part 212a. When decrypting the right information ROm by using the key information Km, the right information decryption part 212a can output the right information to the outside.

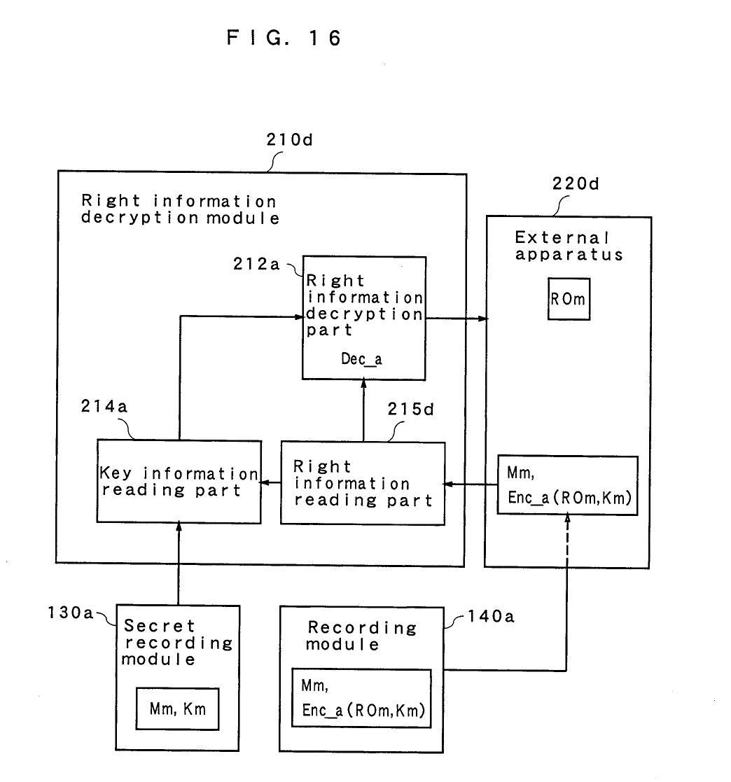

FIG. 15 shows a right information decryption module 210c according to a second modification example of the third embodiment of the present invention. This modification example reads the key information stored in the second modification example of the first embodiment from the secret recording module 130a and decrypts the right information. A right information reading part 215c reads the connected encrypted right information Enc_a (ROm, Km) recorded in the recording module 140a and the key management information Am. Then, the reading part outputs the key management information Am to the key information reading part 214c, and outputs the encrypted right information Enc_a (ROm, Km) to the right information decryption part 212a. The key information reading part 214c reads the key information Km from the address of the key management information Am in the secret recording module 130a, and outputs the right information decryption part 212a. In this manner, the right information decryption part 212a can decrypt the right information ROm.

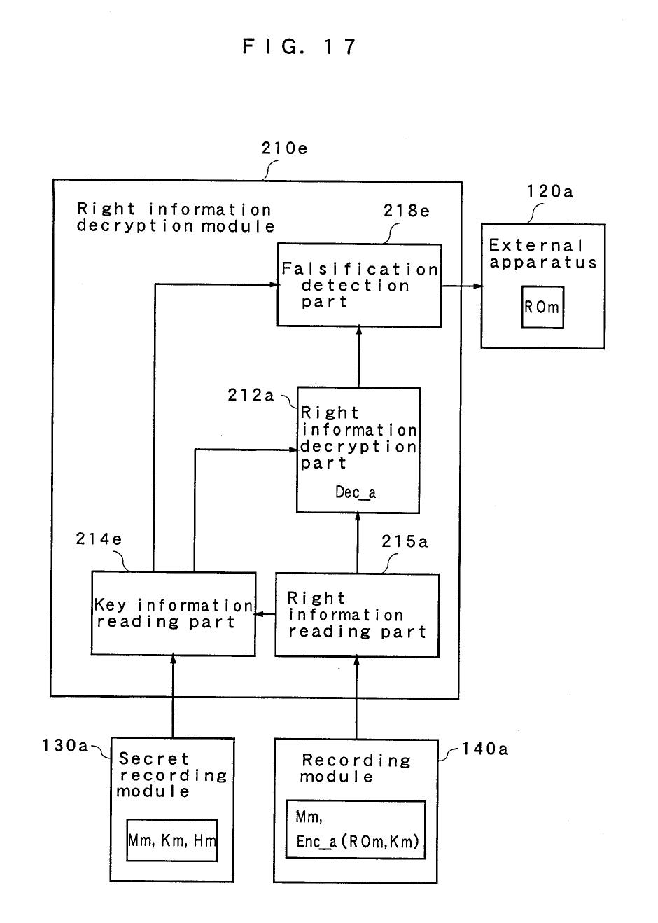

FIG. 16 shows a right information decryption module 210d according to a third modification example of the third embodiment of the present invention. This modification example decrypts the right information stored in the right information encoding module in the third modification example of the first embodiment. In the present modification example, an external apparatus 220d reads the encrypted right information Enc_a (ROm, Km) and the key management information Mm that are connected each other and recorded in the recording module 140a, and inputs the information to an encrypted right information reading part 215d. Other operations are the same as those described above.

### Fourth Embodiment

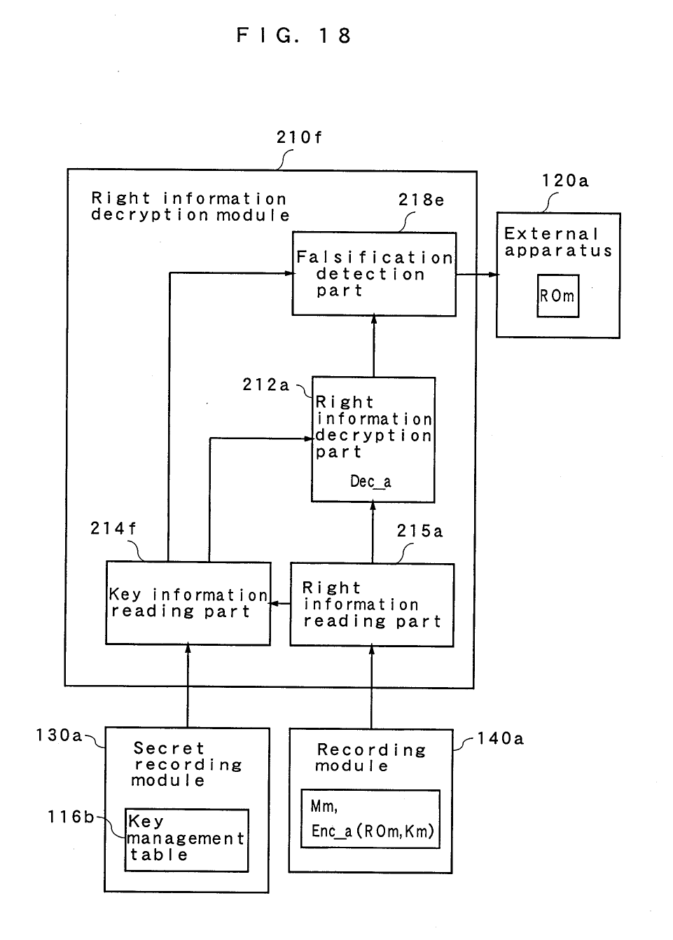

FIG. 17 shows a configuration of a right information decryption module according to a fourth embodiment of the present invention. The right information decryption module 210e is configured by adding a falsification detection part 218e for detecting falsification of the right information to the right information decryption module 210a. To the falsification detection part 218e, the right information ROm decrypted in the right information decryption part 212a is given and the falsification detection data Hm read from the key information reading part 214e is given. The falsification detection part 218e generates right information falsification detection data Hm′ from the decrypted right information ROm. A calculation method of the falsification detection data Hm′ is the same as the calculation method of the falsification detection data Hm. The falsification detection data Hm′ is generated, for example, by using: a hush function such as the SHA1 or the SHA256; and an authentication function such as the CBC-MAC or the CMAC. Then, the detection part compares the falsification detection data Hm′ with Hm, and outputs the right information ROm to the external apparatus 120a only when these data coincide with each other.

In this manner, it can be verified inside the right information decryption module 210e that a state of the encrypted right information Enc_a (ROm, Km) recorded in the recording module 140a is the same as that at the time when the information has been recorded. And, if a malicious user illegally falsified the encrypted right information Enc_a (ROm, Km) recorded in the recoding module, the embodiment can detect in the reading that the falsification has been made. In this case, since the decryption module does not output the right information ROm, the embodiment can make the illegal falsification meaningless.

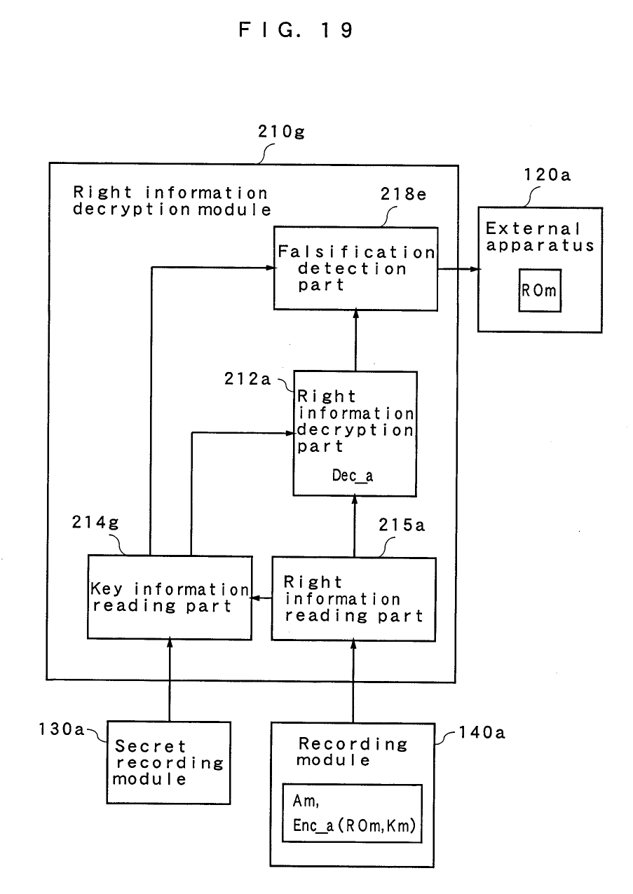

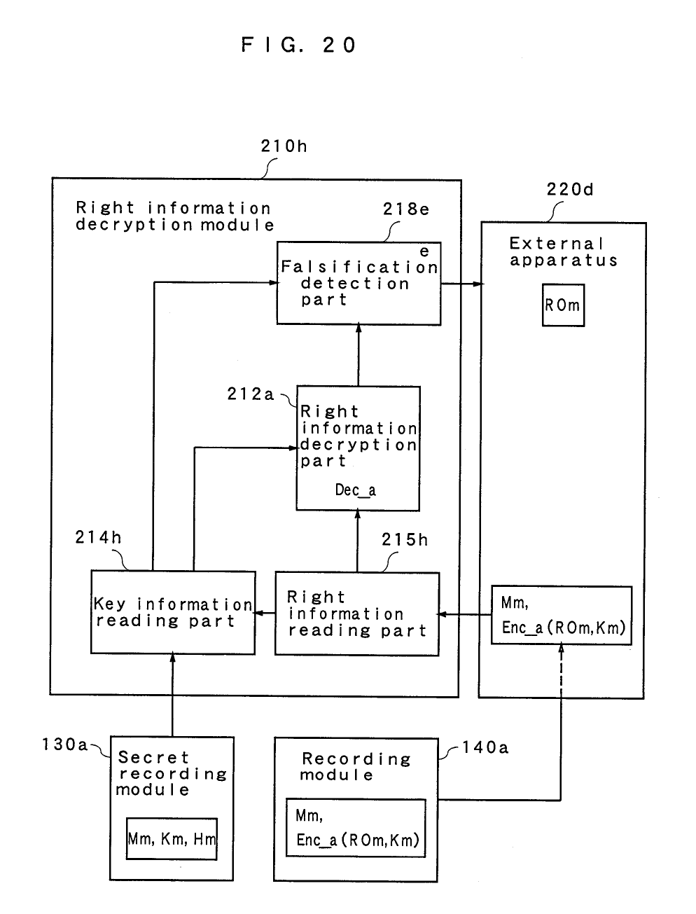

In addition, FIG. 18, FIG. 19, and FIG. 20 show a first, second, and third modification examples of the fourth embodiment, respectively. These right information decryption modules 210f, 210g, and 210h are configured by adding the falsification detection part 218e to the above-mentioned first, second, and third modification examples of the third embodiment, respectively. Accordingly, the modification examples can make the illegal falsification meaningless in the same as the above-mentioned manner.

### Fifth Embodiment

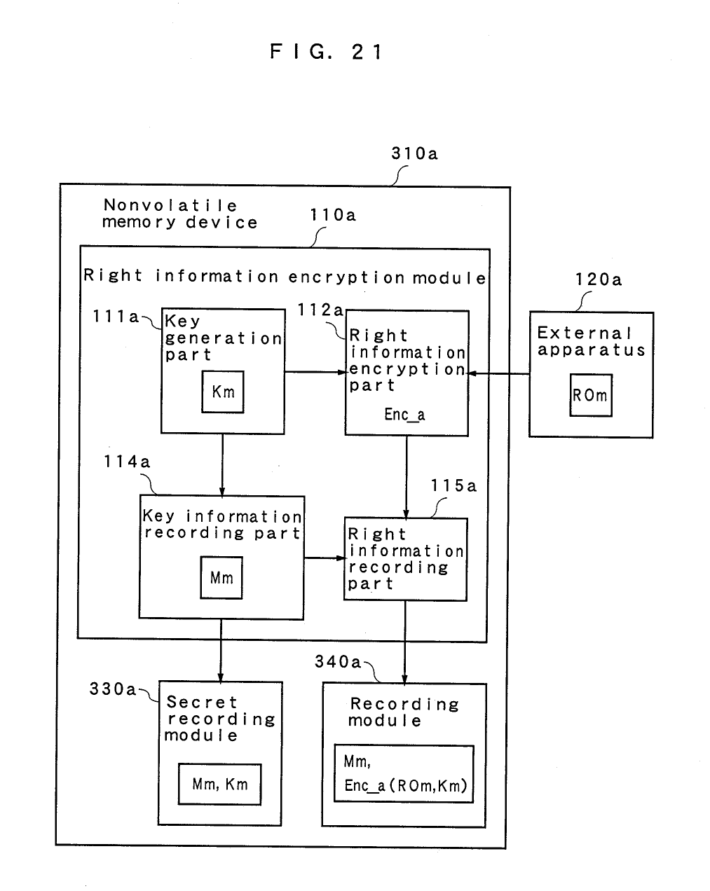

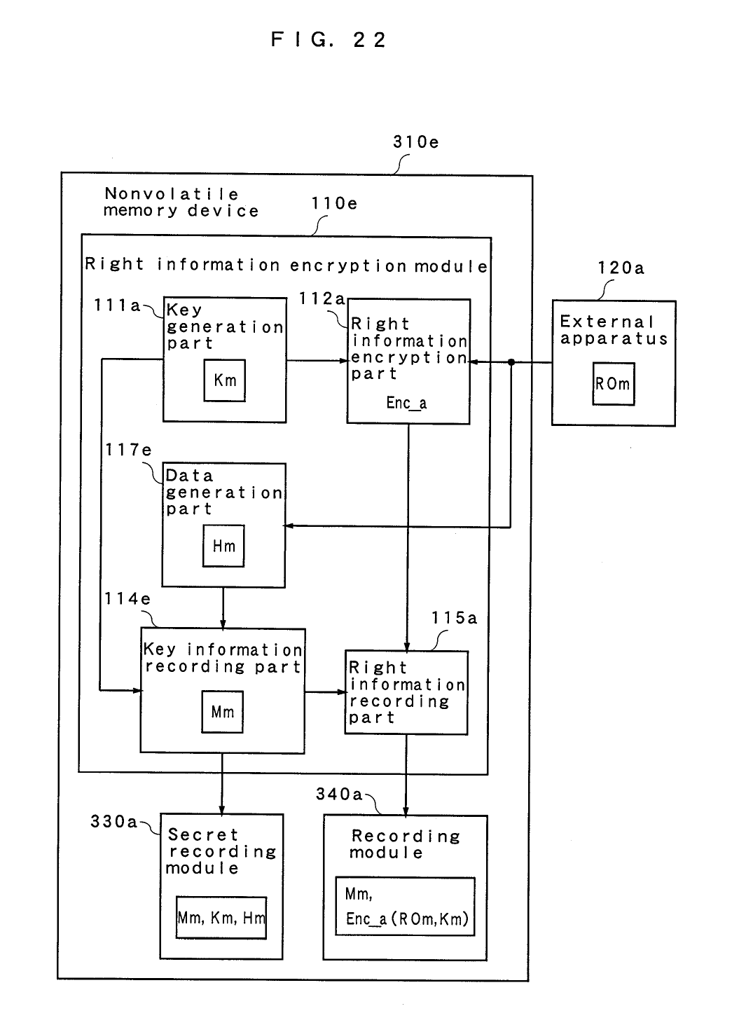

FIG. 21 shows a configuration of a nonvolatile memory device according to a fifth embodiment of the present invention. The nonvolatile memory device 310a is configured by including the right information encryption module 110a, a secret recording module 330a, and a recording module 340a. The nonvolatile memory device 310a can be manufactured as a memory card, for example, a PC card and an SD card (Registered trademark).

The secret recording module 330a and the recording module 340a may be configured by dividing a region of an identical nonvolatile memory. In this case, the division of the region has to be clearly separated. Additionally, since an amount of data to be recorded in the secret recording module is small in the present embodiment, larger memory size can be allocated to the recording module 340a and thus a user's convenience is improved.

The secret module 330a and the recording module 340a may be configured in separate nonvolatile memories. In this case, it is preferable to employ an EEPROM suitable for access in small units of data as the secret module 330a and employ an NAND type flash memory suitable for a large memory capacity as the recording module 340a. The EEPROM is expensive compared to the NAND type flash memory, but since the amount of data to be recorded in the secret recording module 330a is small in the present embodiment, a memory size required for the EEPROM can be reduced and thereby the cost can be reduced.

In addition, the present embodiment does not require the static information IDu specific to each user according to Patent document 1 and encrypts all of the right information ROm recorded in the recoding module 340a is encrypted on the basis of the individual key generated by the key generation part 111a, and even if one piece of the key information is leaked, other pieces of the right information accordingly are not at risk of the illegal use. In addition, since the key information Km is not outputted to the outside of the nonvolatile memory device 310a, the key information Km is not at risk of the leaking to the outside.

Here, in the case of manufacturing the nonvolatile memory device as the memory card, the nonvolatile memory device has an excellent portability and is expected to be used as a recording medium for safely recording the right information of the encrypted contents.

The first to third modification examples can be applied to the fifth embodiment as well as the first embodiment, and the above-mentioned effect can be obtained in that case.

### Sixth Embodiment

FIG. 22 shows a configuration of a nonvolatile memory device according to a sixth embodiment of the present invention. The nonvolatile memory device 310e is configured by including the right information encryption module 110e shown in the second embodiment, the secret recording module 330a, and the recording module 340a. The nonvolatile memory device 310e can be realized as a nonvolatile memory device, for example, a memory card. Also in this case, the embodiment can make the illegal falsification meaningless in addition to the effect of the fifth embodiment.

In addition, the first to third modification examples of the second embodiment can be applied to the fifth embodiment as well as the first embodiment, and the above-mentioned effect can be obtained in that case.

### Seventh Embodiment

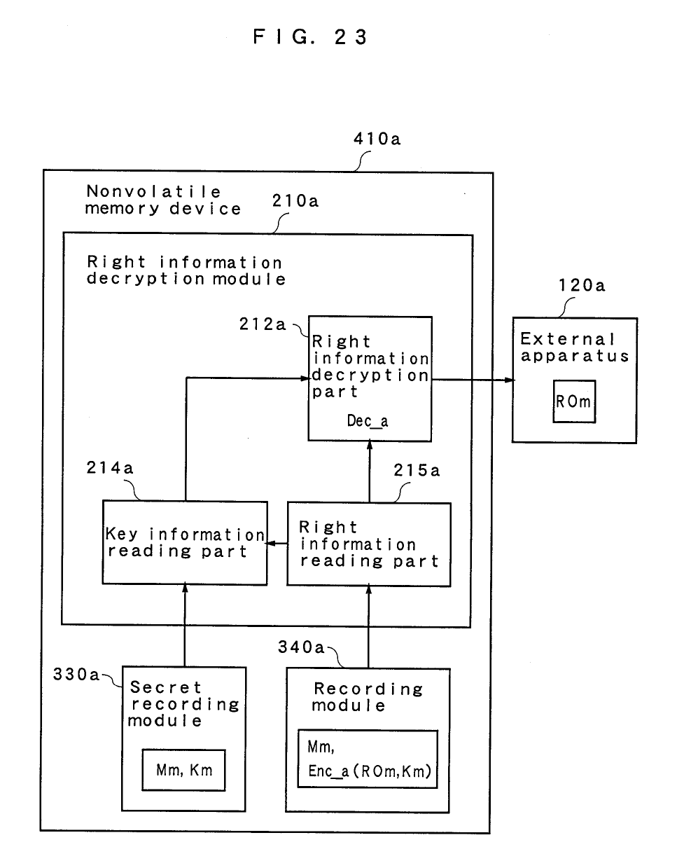

FIG. 23 shows a configuration of a nonvolatile device according to a seventh embodiment of the present invention. The nonvolatile memory device 410a is configured by including the right information decryption module 210a shown in the third embodiment, the secret recording module 330a, and the recording module 340a. Additionally, in this case, the first to third modification examples of the third embodiment can be applied to the present embodiment. The nonvolatile memory device can be manufactured as a memory card, for example, a PC card and an SD card (Registered trademark), and the nonvolatile memory device has an excellent portability and is expected to be used as a recording medium for safely recording the right information of the encrypted contents.

### Eighth Embodiment

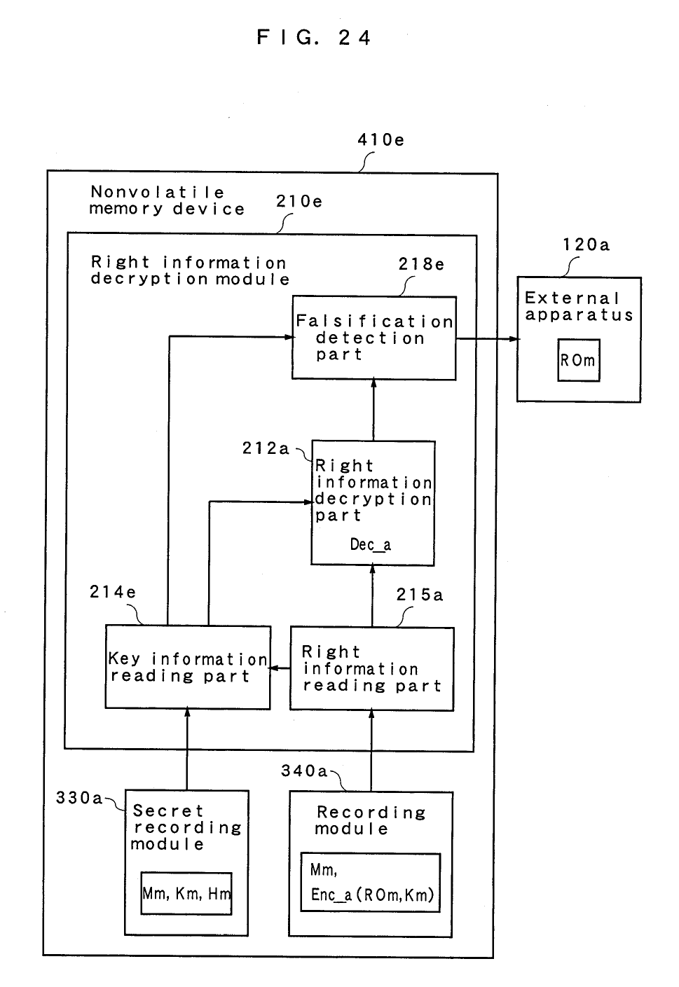

FIG. 24 shows a configuration of a nonvolatile memory device according to an eighth embodiment of the present invention. The nonvolatile memory device is configured by including the right information decryption module 210e shown in the fourth embodiment, the secret recording module 330a, and the recording module 340a. Also in this case, the falsification can be made meaningless by using the right information decryption module including the falsification detection part 218e. Additionally, in this case, the first to third modification examples of the above-mentioned fourth embodiment can be applied to the present embodiment.

### Ninth Embodiment

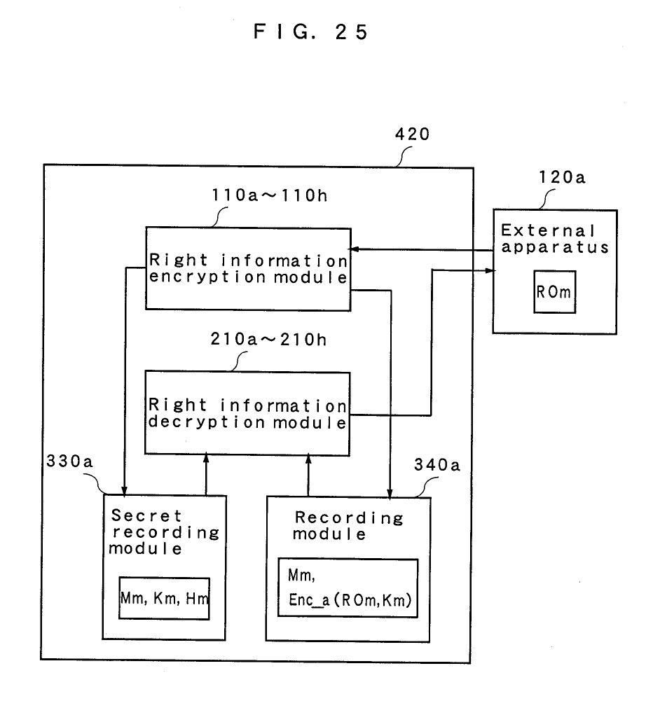

FIG. 25 shows a configuration of a nonvolatile memory device according to a ninth embodiment of the present invention. The nonvolatile memory device 420 according to the present embodiment is configured by including the above-mentioned right information encryption module 110a, right information decryption module 210a, secret recording module 330a, and recording module 340a. In this case, the recording module 340a records the encrypted right information and key management information, and the secret recording module 330a records the key management information and the key information. Moreover, the combined effects can be obtained by reproducing and decrypting the information. It is obvious that the modules described in the first to fourth embodiments, the right information encryption modules 110b to 110h of the respective first to third modification examples, and the right information decryption modules 210b to 210h can be applied to the present embodiment.

### Tenth Embodiment

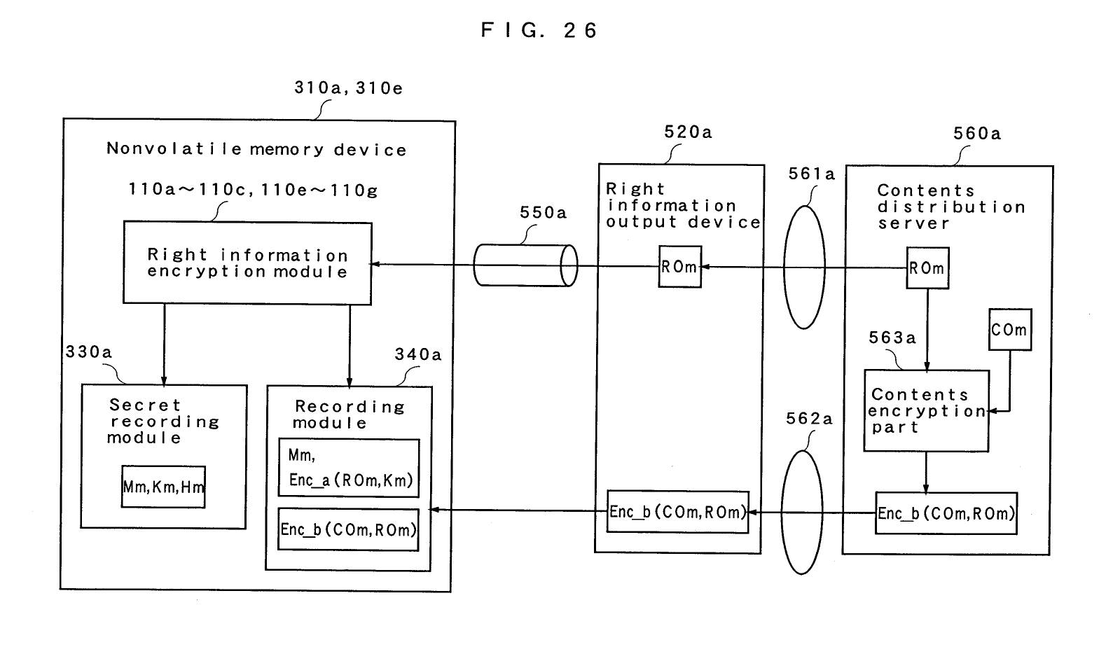

FIG. 26 shows a configuration of a right information recording system according to a tenth embodiment of the present invention. The right information recording system is configured by including any one of the nonvolatile memory devices 310a and 310e of FIG. 21 and FIG. 22 shown in the fifth and sixth embodiments, a right information output device 520a, and a secret communication means 550a for safely transmitting the right information ROm from the right information output device 520a to the nonvolatile memory device 310a or 310e. In the following description, the system employing the nonvolatile memory device 310e of FIG. 22 will be explained. The right information output device 520a is connected to a contents distribution server 560a via a secure network 561a and a non-secure network 562a.

The contents distribution server 560a generates the right information ROm with respect to the contents information COm. Then, the contents encryption part 563a encrypts the contents information Com on the basis of a contents key included in the right information ROm, and calculates the encrypted content Enc_b (COm, ROm). The contents server 560a sends the encrypted contents information to the right information output device 520a via the non-secure network 562a, and sends the right information ROm via the secure network 561a. In addition, the encrypted contents information can be distributed by the means other than the non-secure network 562a, for example, by being recorded in a CD-ROM or a memory card.

The right information output device 520a inputs the right information ROm to the right information encryption part 112a of the nonvolatile memory device 310e through the secret communication means 550a. In addition, since having the recording module 340a accessible from the right information output device 520a, the nonvolatile memory device 310e records the encrypted content Enc_b (COm, ROm) received from the contents server 560a in the recording module 340a. Additionally, in stead of this, the encrypted contents information may be retained in a memory in the right information output device 520a or may be recorded in another recording medium. The following procedures of the encryption and the recording of the right information ROm are the same as those shown in the fifth or the sixth embodiment.

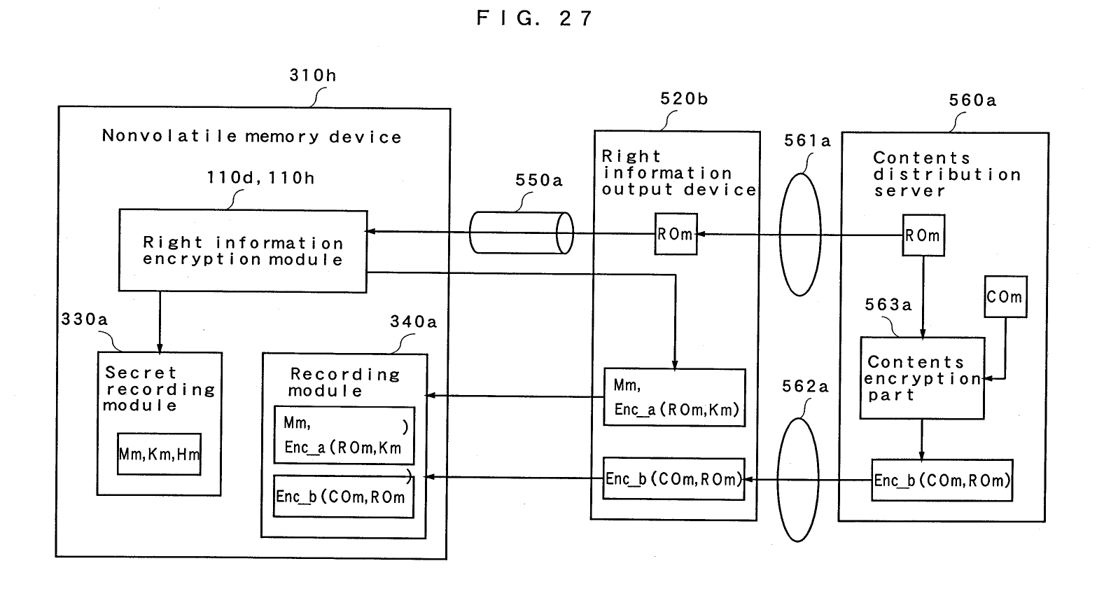

FIG. 27 shows a modification example of the tenth embodiment, and corresponds to the respective third modification examples of the fifth and sixth embodiments. In the present modification example, the nonvolatile memory device 310h connects the key management information Mm to the encrypted right information Enc_a (ROm, Km), and once outputs them to the right information output device 520b. The right information output device 520b outputs the information to the recording module 340a, and the recording module 340a records the information. The others are the same as those of the case of FIG. 26.

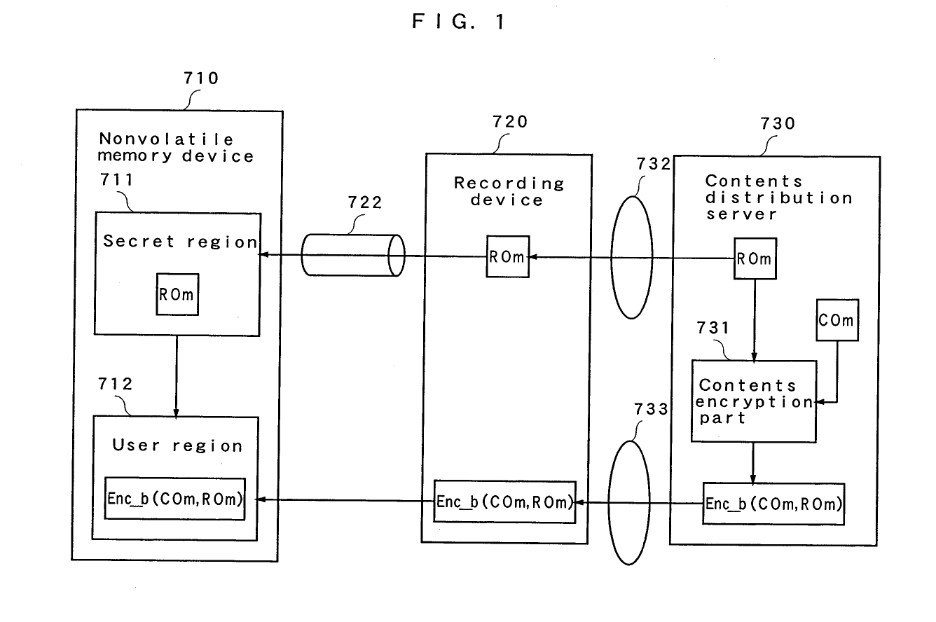

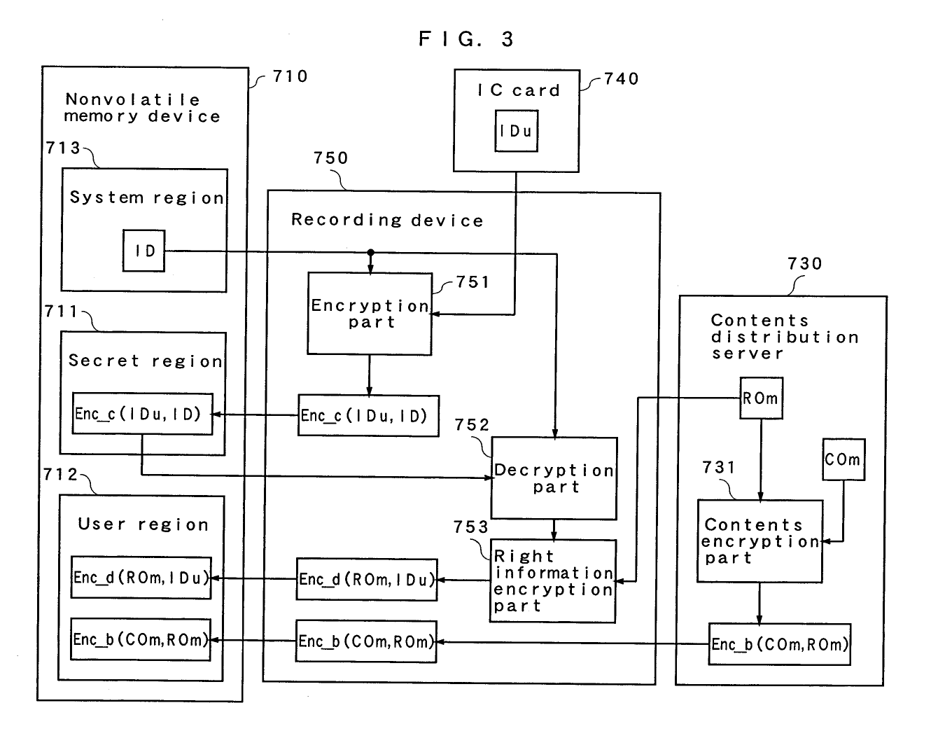

Patent document 1 shown in FIG. 3 has to include the encryption part 751, the decryption part 752, and the right information encryption part 753 in the recording device 750. Compared to this, the present embodiment does not have to include them in the right information output devices 520a and 520b. Accordingly, the same configuration as that of the conventional recording device 720 shown in FIG. 1 can be employed, and thus the configuration can be applied to the present embodiment when the recording device is not redesigned.

### Eleventh Embodiment

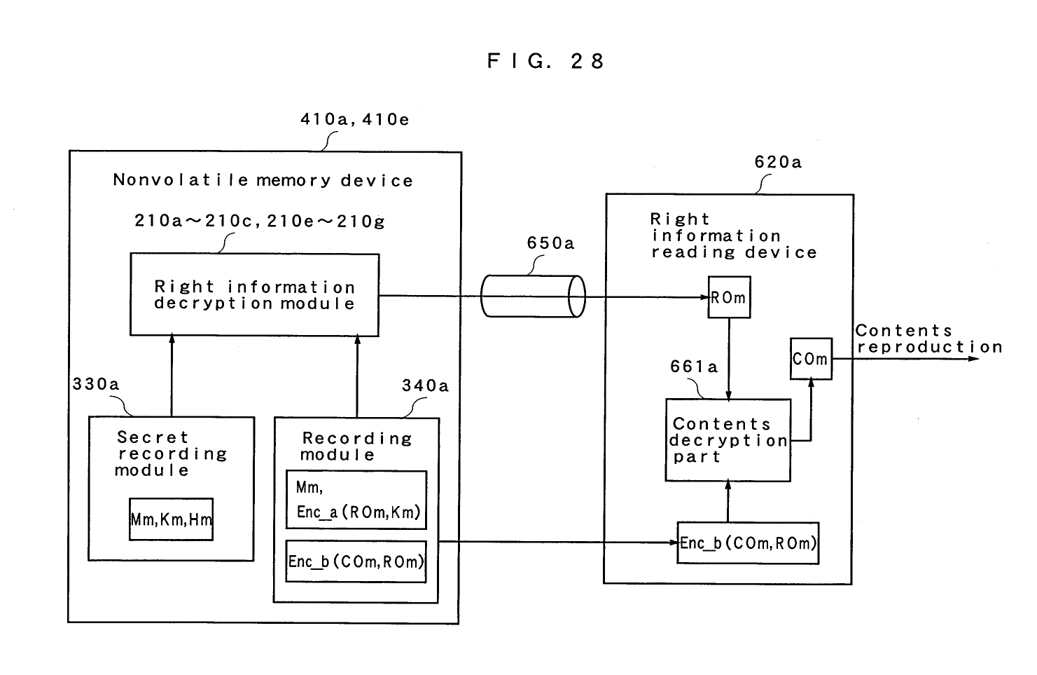

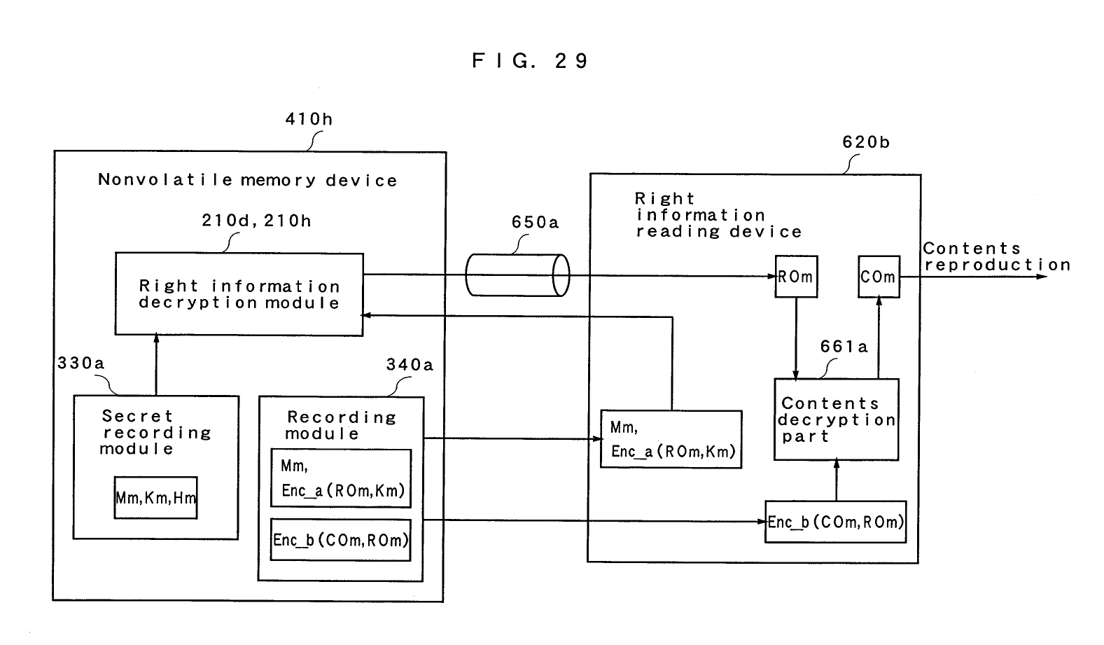

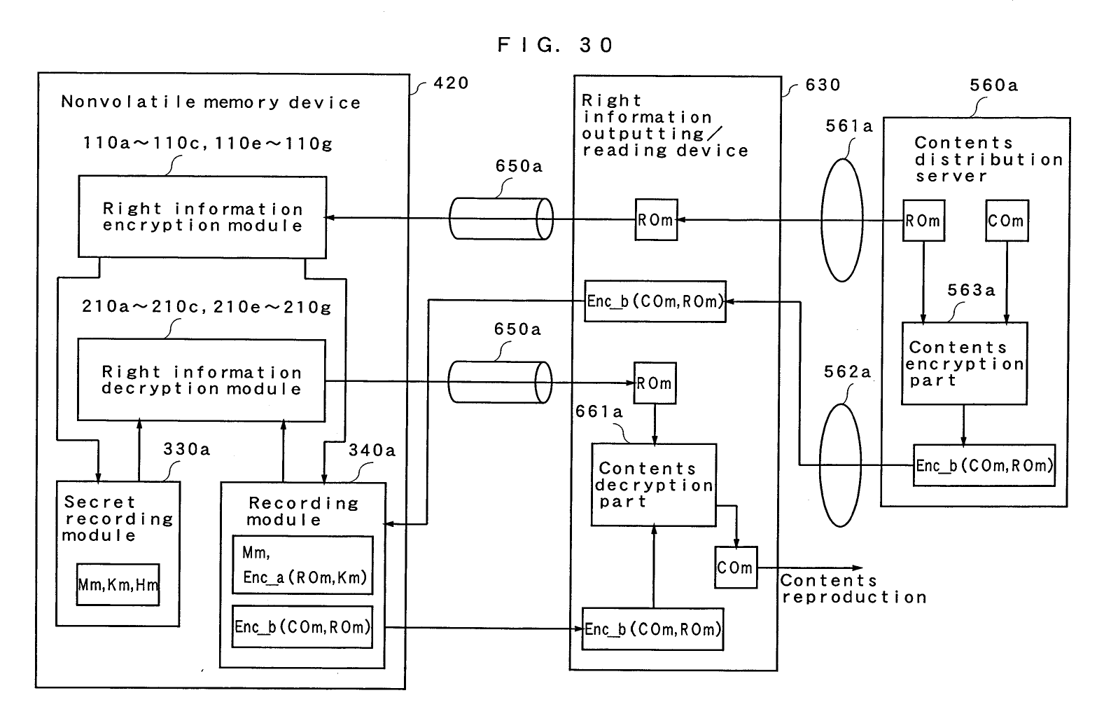

FIG. 28 and FIG. 29 show configurations of right information reading systems according to an eleventh embodiment of the present invention. As shown in FIG. 23 and FIG. 24, the right information reading system is configured by including any one of the nonvolatile memory devices 410a and 410e described in the seventh and eighth embodiments, a right information reading device 620a, and a secret communication means 650a for safely sending the right information ROm from the nonvolatile memory device 410a or 410e to the right information reading device 620a.

In the following description, the system employing the nonvolatile memory device 410e will be explained. When the falsification has not been detected, the nonvolatile memory device 410e outputs the right information ROm to the right information reading device 620a through the secret communication means 650a in accordance with the procedure shown in the eighth embodiment. The right information reading device 620a decrypts the encrypted content Enc_b (COm, ROm) by using the contents key included in the ROm at the contents decryption part 661a, and outputs the contents Com.

Here, an example of the encrypted content Enc_b (COm, ROm) recorded in the recording module 340a is shown, but a recording location of the encrypted content Enc_b (COm, ROm) may be other than the recording module 340a.

In FIG. 29, a right information reading device 620b reads the key management information Mm and the encrypted right information Enc_a (ROm, Km) connected each other from the recording module 340a of a nonvolatile memory device 410h, and inputs them to a right information reading part 215h. The others are the same as those of the case of FIG. 28.

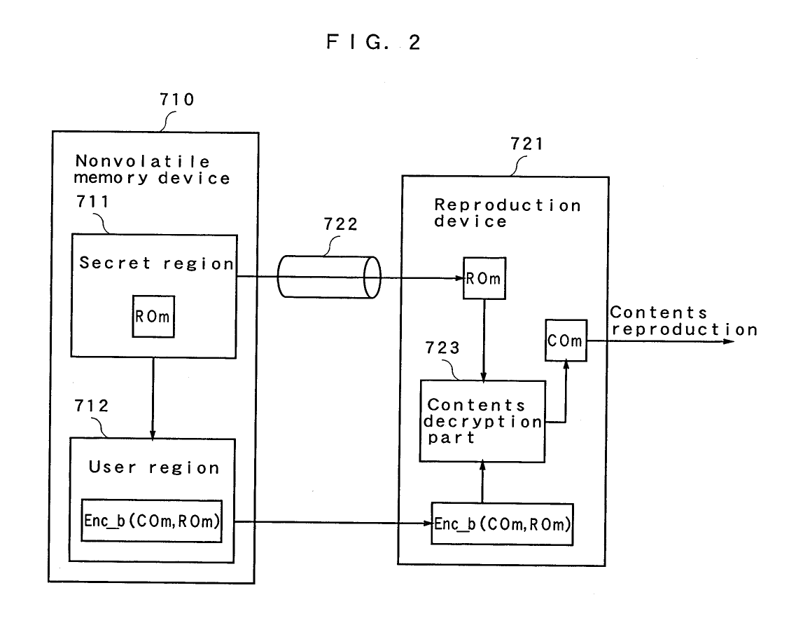

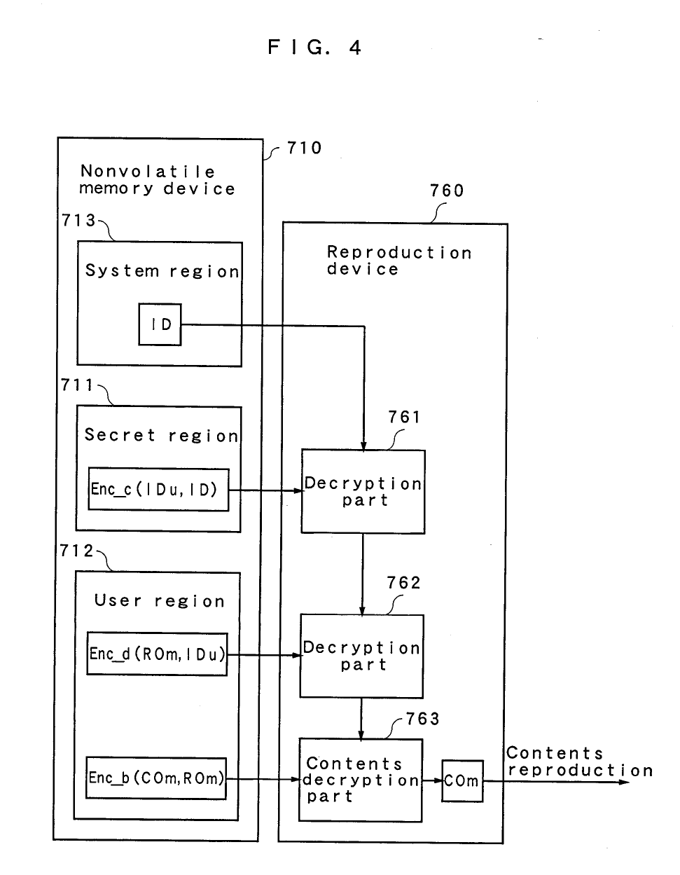

Patent document 1 shown in FIG. 4 has to include the decryption part 761 for the static information and the decryption part 762 for the right information in the reproducing device 760. The present embodiment does not have to include these encryption parts in the right information reading devices 620a and 620b. Accordingly, the same configuration as that of the conventional recording device 721 shown in FIG. 2 can be employed, and thus the configuration can be applied to the present embodiment when the recording device is not redesigned.

### Twelfth Embodiment

FIG. 30 shows a configuration of a right information recording/reproducing system according to a twelfth embodiment of the present invention. The system includes the nonvolatile memory device 420 and a right information outputting/reading device 630. The nonvolatile memory device 420 is the nonvolatile memory device shown in the fifth or sixth embodiment, and the nonvolatile memory device 420 encrypts the right information ROm from the right information outputting/reading device 630 and records the information in a recording medium, and then decrypts the information. The right information outputting/reading device 630 writes the right information in the nonvolatile memory device 420, and, in the nonvolatile memory device, the right information encryption modules 110a to 110c and 110e to 110g encrypt the information and write the encrypted information in the secret recording module 330a and the recording module 340a. And, in the decryption, the right information decryption modules 210a to 210c and 210e to 210g read the encrypted information, and the contents decryption part 661a decrypts the right information. Accordingly, this can safely record the contents key by using a small recording region and can decrypt contents. Also in this case, the encrypted right information may be written and read via the right information outputting/reading device.

Meanwhile, a nonvolatile memory device according to the present invention may comprise: a right information encryption module for encrypting and recording right information; a right information decryption module for reading and decrypting the encrypted right information; a secret recording module for recording highly-secret information; and a recording module for recording arbitrary information, wherein said right information encryption module may include: a key generation part for generating key information used for encrypting the right information; a falsification detection data generation part for generating falsification detection data used for falsification detection of said right information from said right information; a right information encryption part for generating encrypted right information by encrypting the right information of an encrypted content inputted from an external device by using the key information generated by said key generation part; a key information recording part for generating key management information that relates the key information generated by said key generation part to the encrypted right information and for relating said key information, said key management information, and said falsification detection data each other and for recording said key information and key management information in said secret recording module; and a right information recording part for relating said key management information to said encrypted right information and for recording said key management information and said encrypted right information in said recording module, and wherein said right information decryption module may include: a right information reading part for reading the encrypted right information and the key management information that are connected each other and are recorded in said recording module; a key information reading part for reading said falsification detection data and the key information related to said key management information from said secret recording module; a right information decryption part for decrypting the encrypted right information by using said key information; and a falsification detection part for detecting falsification of the right information by using said falsification detection data and outputting the decrypted right information only in a case where the falsification has not been detected.

A nonvolatile memory device according to the present invention may comprise: a right information encryption module for encrypting and recording right information; a secret recording module for recording highly-secret information; and a recording module for recording arbitrary information, wherein said right information encryption module may include: a key generation part for generating key information used for encrypting the right information; a falsification detection data generation part for generating falsification detection data used for falsification detection of said right information from said right information; a right information encryption part for generating encrypted right information by encrypting the right information of an encrypted content inputted from an external device by using the key information generated by said key generation part; a key information recording part for generating key management information that relates the key information generated by said key generation part to the encrypted right information and for relating said key information to said key management information and for recording said key information and key management information in said secret recording module; and a right information recording part for relating said key management information to said encrypted right information and for recording said key management information and said encrypted right information in said recording module.

A nonvolatile memory device according to the present invention may comprise: a right information decryption module for reading and decrypting the encrypted right information; a secret recording module for recording highly-secret information; and a recording module for recording arbitrary information, wherein said right information decryption module may include: a right information reading part for reading key management information and encrypted right information obtained by encrypting right information of an encrypted content, the key management information and the encrypted right information being related each other and recorded in said recording module; a key information reading part for reading the key information related to said key management information and falsification detection data used for falsification detection from said secret recording module; a right information decryption part for decrypting the encrypted right information by using said key information; and a falsification detection part for detecting falsification of the right information by using said falsification detection data and outputting the decrypted right information only in a case where the falsification has not been detected.

A right information encryption module according to the present invention may comprise: a key generation part for generating key information used for encrypting right information; a falsification detection data generation part for generating falsification detection data used for falsification detection of said right information from said right information; a right information encryption part for generating encrypted right information by encrypting the right information of an encrypted content inputted from an external device by using the key information generated by said key generation part; a key information recording part for generating key management information that relates the key information generated by said key generation part to the encrypted right information generated by said right information encryption part and for relating said key information, said key management information, and said falsification detection data each other and outputting said key information and key management information to an external device; and a right information recording part for relating said key management information to said encrypted right information and for outputting said key management information and said encrypted right information to the external device.

A right information decryption module according to the present invention may comprise: a right information reading part for inputting encrypted right information and key management information that are related each other from an external device; a key information reading part for inputting key information related to said key management information and falsification detection data used for falsification detection of the right information from the external device; a right information decryption part for decrypting the encrypted right information by using said key information and for outputting the decrypted information to the external device; and a falsification detection part for detecting falsification of the right information by using said falsification detection data and outputting the decrypted right information only in a case where the falsification has not been detected.

### INDUSTRIAL APPLICABILITY

The present invention can be expected to serve as not only a conventional memory card but also a right information protection function module incorporated in an audio apparatus and video apparatus having a storage function that essentially requires the protection of the right information, the apparatuses being applied to a network type contents distribution service.

1. A nonvolatile memory device comprising:
a right information encryption module for encrypting and recording right information;
a right information decryption module for reading and decrypting the encrypted right information;
a secret recording module for recording highly-secret information; and
a recording module for recording arbitrary information, wherein
said right information encryption module includes:
a key generation part for generating key information used for encrypting the right information;
a right information encryption part for generating encrypted right information by encrypting the right information of an encrypted content inputted from an external device by using the key information generated by said key generation part;
a key information recording part for generating key management information that relates the key information generated by said key generation part to the encrypted right information and for relating said key information to said key management information and for recording said key information and key management information in said secret recording module; and
a right information recording part for relating said key management information to said encrypted right information and for recording said key management information and said encrypted right information in said recording module, and wherein
said right information decryption module includes:
a right information reading part for reading the encrypted right information and the key management information that are connected each other and are recorded in said recording module;
a key information reading part for reading the key information related to said key management information from said secret recording module; and
a right information decryption part for decrypting the encrypted right information by using said key information.

2. A nonvolatile memory device comprising:
a right information encryption module for encrypting and recording right information;
a secret recording module for recording highly-secret information; and
a recording module for recording arbitrary information, wherein
said right information encryption module includes:
a key generation part for generating key information used for encrypting the right information;
a right information encryption part for generating encrypted right information by encrypting the right information of an encrypted content inputted from an external device by using the key information generated by said key generation part;
a key information recording part for generating key management information that relates the key information generated by said key generation part to the encrypted right information and for relating said key information to said key management information and for recording said key information and key management information in said secret recording module; and
a right information recording part for relating said key management information to said encrypted right information and for recording said key management information and said encrypted right information in said recording module.

3. The nonvolatile memory device according to claim 1, wherein
said right information recording part relates said key management information to said encrypted right information and outputs said key management information and said encrypted right information to an external apparatus and
said external apparatus outputs said key management information and said encrypted right information to said recording module.

4. The nonvolatile memory device according to claim 2, wherein
said right information recording part relates said key management information to said encrypted right information and outputs said key management information and said encrypted right information to an external apparatus and
said external apparatus outputs said key management information and said encrypted right information to said recording module.

5. A nonvolatile memory device comprising:
a right information decryption module for reading and decrypting the encrypted right information;
a secret recording module for recording highly-secret information; and
a recording module for recording arbitrary information, wherein
said right information decryption module includes:
a right information reading part for reading key management information and encrypted right information obtained by encrypting right information of an encrypted content, the key management information and the encrypted right information being related each other and recorded in said recording module;
a key information reading part for reading the key information related to said key management information from said secret recording module; and
a right information decryption part for decrypting the encrypted right information by using said key information.

6. The nonvolatile memory device according to claim 5, wherein
said key management information and said encrypted right information that are connected each other are once read from said recording module by an external apparatus and inputted to said right information reading part.

7. A right information recording/reading system comprising:
a nonvolatile memory device;
a right information outputting/reading device for writing and reading right information in and from said nonvolatile memory device; and
a secret communication means for carrying out a secret communication between said nonvolatile memory device and said right information outputting/reading device, wherein
said nonvolatile memory device comprises:
a right information encryption module for encrypting and recording right information;
a right information decryption module for reading and decrypting the encrypted right information;
a secret recording module for recording highly-secret information; and
a recording module for recording arbitrary information,
said right information encryption module includes:
a key generation part for generating key information used for encrypting the right information;
a right information encryption part for generating encrypted right information by encrypting the right information of an encrypted content inputted from an external device by using the key information generated by said key generation part;
a key information recording part for generating key management information that relates the key information generated by said key generation part to the encrypted right information and for relating said key information to said key management information and recording said key information and key management information in said secret recording module; and
a right information recording part for relating said key management information to said encrypted right information and for recording said key management information and said encrypted right information in said recording module,
said right information decryption module includes:
a right information reading part for reading the encrypted right information and the key management information that are connected each other and are recorded in said recording module;
a key information reading part for reading the key information related to said key management information from said secret recording module; and
a right information decryption part for decrypting the encrypted right information by using said key information,
said right information outputting/reading device inputs the right information of the encrypted content to said nonvolatile memory device by using said secret communication means, and
said nonvolatile memory device outputs the right information of the encrypted content to said right information outputting/reading device by using said secret communication means.

8. A right information recording/reading system comprising:
a nonvolatile memory device;
a right information output device for writing right information in said nonvolatile memory device; and
a secret communication means for carrying out a secret communication between said nonvolatile memory device and said right information output device, wherein
said nonvolatile memory device comprises:
a right information encryption module for encrypting and recording right information;
a secret recording module for recording highly-secret information; and
a recording module for recording arbitrary information,
said right information encryption module includes:
a key generation part for generating key information used for encrypting the right information;
a right information encryption part for generating encrypted right information by encrypting the right information of an encrypted content inputted from an external device by using the key information generated by said key generation part;
a key information recording part for generating key management information that relates the key information generated by said key generation part to the encrypted right information and for relating said key information to said key management information and recording said key information and key management information in said secret recording module; and
a right information recording part for relating said key management information to said encrypted right information and for recording said key management information and said encrypted right information in said recording module, and
said right information output device outputs the right information of the encrypted content to said nonvolatile memory device by using said secret communication means.

9. A right information recording/reading system comprising:
a nonvolatile memory device;
a right information output device for writing right information in said nonvolatile memory device; and
a secret communication means for carrying out a secret communication between said nonvolatile memory device and said right information output device, wherein
said nonvolatile memory device comprises:
a right information decryption module for reading and decrypting the encrypted right information;
a secret recording module for recording highly-secret information; and
a recording module for recording arbitrary information,
said right information decryption module includes:
a right information reading part for reading key management information and encrypted right information obtained by encrypting right information of an encrypted content, the key management information and the encrypted right information being related each other and recorded in said recording module;
a key information reading part for reading the key information related to said key management information from said secret recording module; and
a right information decryption part for decrypting the encrypted right information by using said key information, and
said nonvolatile memory device outputs the decrypted right information of the encrypted content to said right information reading device by using said secret communication means.

10. A right information encryption module comprising:
a key generation part for generating key information used for encrypting right information;
a right information encryption part for generating encrypted right information by encrypting the right information of an encrypted content inputted from an external device by using the key information generated by said key generation part;
a key information recording part for generating key management information that relates the key information generated by said key generation part to the encrypted right information generated by said right information encryption part and for relating said key information to said key management information and outputting said key information and key management information to an external device; and
a right information recording part for relating said key management information to said encrypted right information and for recording said key management information and said encrypted right information in said recording module.

11. The right information encryption module according to claim 10, wherein
said right information recording part relates said key management information to said encrypted right information and outputs said key management information and said encrypted right information to the external device.

12. A right information decryption module comprising:
a right information reading part for inputting encrypted right information and key management information that are related each other from an external device;
a key information reading part for inputting key information related to said key management information from the external device; and
a right information decryption part for decrypting the encrypted right information by using said key information and for outputting the decrypted information to the external device.

13. The right information decryption module according to claim 12, wherein
said right information reading part inputs said key management information and said encrypted right information that are related each other from the external device.
